(19) United States
(12) Patent Application Publication
(10) Pub. No.: US 2019/0021385 A1
(43) Pub. Date: Jan. 24, 2019

(54) ORALLY DISSOLVABLE COMPOSITIONS FOR NUTRITION SUPPLEMENTATION

(71) Applicant: Exeltis USA, Inc., Florham Park, NJ (US)

(72) Inventor: Eduardo FERNANDEZ, Hoboken, NJ (US)

(21) Appl. No.: 16/040,704

(22) Filed: Jul. 20, 2018

Related U.S. Application Data
(60) Provisional application No. 62/535,455, filed on Jul. 21, 2017.

(51) Int. Cl. A23L 33/155; A23L 33/12; A23L 33/16

(52) U.S. Cl. CPC A23L 33/155; A23V 2002/00; A23L 33/16; A23L 33/12

(57) ABSTRACT

Orally dissolvable compositions are provided which comprise a nutritional supplement for subjects in physiologically stressful states. The orally dissolvable compositions may comprise one or more water-soluble film strips for oral (buccal or sublingual) administration to a subject. The composition of the nutritional supplement may comprise combinations of vitamin A, vitamin C, vitamin D3, vitamin E, vitamin B1, vitamin B2, niacin, vitamin B6, folic acid, vitamin B12, iron, iodine, magnesium, zinc, copper, omega-3 fatty acids, vitamin D, choline, and one or more flavorants.

### CROSS-REFERENCE TO RELATED APPLICATIONS

This application claims the benefit of U.S. Provisional Patent Application Ser. No. 62/535,455, entitled “ORALLY DISSOLVABLE COMPOSITIONS FOR NUTRITION SUPPLEMENTATION,” filed Jul. 21, 2017, which is hereby incorporated herein by reference in its entirety.

### FIELD OF THE INVENTION

The present invention relates to orally dissolvable compositions for nutritional supplementation, methods of administration of various orally dissolvable compositions for nutritional supplementation, and kits comprising various orally dissolvable compositions for nutritional supplementation in, for example, subjects in physiologically stressful states, such as those that occur during pre-pregnancy, pregnancy and/or lactation periods.

### BACKGROUND

Nutrition plays a critical role in maintaining good health. Proper nutrition prevents dietary deficiencies, and also protects against the development of disease. When the body faces physiological stress, proper nutrition plays an increasingly important role. For example, pregnancy and lactation are among the most nutritionally volatile and physiologically stressful periods and processes in the lifetimes of women. Vitamin and mineral needs are almost universally increased during these natural processes. Increased vitamin and mineral needs during these times are almost always due to elevated metabolic demand, increased plasma volume, increased levels of blood cells, decreased concentrations of nutrients, and decreased concentrations of nutrient-binding proteins.

When increased nutrient needs occur during pregnancy, lactation, or any other physiologically stressful state, nutritional supplementation serves a vital role in maintaining good health. Nutritional supplementation is especially pertinent to women contemplating conceiving a child because optimizing specific nutrients before, during, and after the physiological processes of pregnancy or lactation can have profound, positive, and comprehensive impacts upon the overall wellness of the developing child as well as on the safety and health of the pregnant woman.

Supplementation with certain vitamins and minerals serves a role in protecting against disease and contributes to the overall health of the pregnant woman and developing child by playing integral roles in physiological mechanisms that serve to prevent, treat and/or alleviate the occurrence or negative effects of some diseases. Traditionally, nutritional supplements for subjects in physiologically stressful states, such as those that occur during pre-pregnancy, pregnancy and/or lactation periods, are made available in the forms of pills, tablets, chewable tablets, capsules, liquid gel caps, and the like. Such traditional delivery systems present a number of problems for women in one or more of these categories, particularly relating to compliance. Alternative systems and methods for drug delivery include continued development in the area of thin-film drug delivery (TFDD). In TFDD, a dissolving film or oral strip is prepared using hydrophilic polymers that rapidly dissolve in the mouth (for instance, in the cheek (buccally) or under the tongue (sublingually)). The target composition is delivered to the systemic circulation via dissolution when contact with liquid is made.

The use of TFDD in nutritional supplementation offers benefits over the traditional alternatives thereto. For example, delivery of a target compound or composition through TFDD has the potential to improve the onset of action. This is because compounds or compositions delivered using thin-film strips typically do not enter the blood stream via the gastrointestinal (GI) tract and thus are not subject to degradation from e.g., stomach acids, digestive enzymes, and other first-pass effects. See Izhar Ahmed Syed, S. Krishna, Buccal Films Drug Delivery Device: A Review, 2 ASIAN J. PHARM. ED. & RES. 3 (Sept. 2013). Relatedly, TFDD is further understood to facilitate absorption significantly faster than, for instance, an oral tablet. Id. Accordingly, use of TFDD in conjunction with nutritional supplementation may enhance the efficacy and safety profile of a target compound or composition for delivery.

Additionally, and significantly, the use of TFDD also has the potential to improve compliance due to the intuitive nature of the dosage form and its inherent ease of administration. Id. Further, the rapid dissolution of the strips without the need for water provides an alternative to subjects with swallowing disorders and/or particularly for subjects suffering from nausea, a well-known symptom associated with pregnancy. See id.

Due to the significant impact that nutritional supplements may have on the overall wellness of a pregnant woman and her developing child, as well as any subject in a physiologically stressful state, solutions which would increase the efficacy, subject compliance, and convenient administration of these nutritional supplementation compositions are currently needed.

### SUMMARY OF THE INVENTION

The present invention provides orally dissolvable compositions for both prophylactic and therapeutic nutritional supplementation. Specifically, for example, the present invention relates to novel compositions of vitamins, nutrients, minerals, and omega-3 fatty acids that can be used to supplement the nutritional deficiencies observed in subjects throughout physiologically stressful states, which, in certain embodiments of the present invention, include prenatal, pregnant and breast-feeding subjects. In embodiments of the invention, other non-nutrient components may also be included in the compositions as well.

In one embodiment, a composition for administration to a pre-natal, pregnant, post-natal or breastfeeding subject, is presented. The orally dissolvable composition comprises a first water-soluble film comprising one or more vitamins and minerals selected from the group consisting of vitamin A, vitamin C, vitamin D₃, vitamin E, vitamin B₁, vitamin B₂, niacin, vitamin B₆, folic acid, vitamin B₁₂, iron, iodine, magnesium, zinc, and copper.

In a separate aspect, the orally dissolvable composition further comprises omega-3 fatty acids.

In a separate aspect, the orally dissolvable composition further comprises one or more of docahexaenoic acid (or docosahexaenoic acid, DHA) and eicosapentaenoic acid (EPA).

In a separate aspect, the orally dissolvable composition further comprises omega-3 fatty acids derived from algae.

In another separate aspect, the omega-3 fatty acids are provided on a second water-soluble film.

In another separate aspect, the one or more vitamins and minerals comprise iron, vitamin B₆, folic acid, and vitamin B₁₂.

In another separate aspect, the one or more vitamins and minerals comprise about 27 mg iron, about 2.5 mg vitamin B₆, about 1 mg folic acid, and about 12 mcg vitamin B₁₂.

In another separate aspect, the one or more vitamins comprise folic acid, vitamin D, vitamin B₆, vitamin B₁₂, wherein the composition further comprises one or more flavorants.

In another separate aspect, the one of more vitamins and minerals comprise at least about 1 mg of folic acid, about 500 IU to about 2,000 IU of vitamin D, about 2 mg to about 5 mg of vitamin B₆, at least about 6 mcg to about 20 mcg of vitamin B₁₂, wherein the first water-soluble film further comprises at least about 0 mg to about 200 mg of the one or more flavorants.

In another separate aspect, the one or more vitamins and minerals comprise vitamin D₃, vitamin B₆, folic acid, vitamin B₁₂, iron and iodine.

In another separate aspect, the one or more vitamins and minerals comprise vitamin A, vitamin C, vitamin D, vitamin E, niacin, vitamin B₆, folic acid, vitamin B₁₂, iodine, iron, and choline.

In another separate aspect, the total amount of the one or more vitamins and minerals on the first water-soluble film is about 50 mg or less.

In another separate aspect, the total amount of the one or more vitamins and minerals on the first water-soluble film is about 30 mg or less.

In another separate aspect, the iron is encapsulated.

In another separate aspect, the folic acid is encapsulated.

In another separate aspect, one or more of the first or second water soluble films comprises one or a combination of polymers selected from the group consisting of pullulan, hydrocolloids, β-glucan, maltodextrin, celluloses, including hydroxypropyl methylcellulose, hydroxyethyl cellulose, hydroxypropyl cellulose, carboxymethyl cellulose, methylcellulose, hydroxymethylcellulose, hydroxyethylcellulose, polyvinyl pyrrolidone, polyvinyl alcohol, sodium alginate, polyethylene glycol, natural gums, such as locust bean gum, carrageenan gum, xanthan gum, tragacanth gum, guar gum, acacia gum, arabic gum, karaya, ghatti, tamarind gum, polyacrylic acid, methyl methacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein.

In another separate aspect, one or more of the first or second water-soluble films does not comprise an ingredient derived from animal sources.

In another separate aspect, one or more of the first or second water-soluble films consist of ingredients derived only from plant sources.

In another separate aspect, one or more of the first or second water-soluble films comprise at least one stabilizing agent, at least one coloring agent, water, at least one sweetening agent, and at least one cooling agent and at least one surfactant.

In one embodiment of the invention, a kit is presented. The kit comprises a first water-soluble film comprising one or more vitamins and minerals selected from the group consisting of vitamin A, vitamin C, vitamin D₃, vitamin E, vitamin B₁, vitamin B₂, niacin, vitamin B₆, folic acid, vitamin B₁₂, iron, iodine, magnesium, zinc, and copper, and one or more pharmaceutically acceptable carriers. The kit further comprises a second water soluble film.

In a separate aspect, the second water-soluble film further comprises omega-3 fatty acids and one or more pharmaceutically-acceptable carriers.

In a separate aspect, the omega-3 fatty acids comprise one or more of DHA and EPA.

In a separate aspect, the omega-3 fatty acids are derived from algae.

In another separate aspect, the first water-soluble film comprises iron, vitamin B₆, folic acid, and vitamin B₁₂.

In another separate aspect, the first water-soluble film comprises about 27 mg iron, about 2.5 mg vitamin B₆, about 1 mg folic acid, and about 12 mcg vitamin B₁₂.

In another separate aspect, the first water-soluble film comprises folic acid, vitamin D, vitamin B₆, vitamin B₁₂, the first water soluble film further comprising one or more flavorants.

In another separate aspect, the first water-soluble film comprises at least about 1 mg of folic acid, about 500 IU to about 2,000 IU of vitamin D, about 2 mg to about 5 mg of vitamin B₆, at least about 6 mcg to about 20 mcg of vitamin B₁₂, wherein the first water-soluble film further comprises at least about 0 mg to about 200 mg of the one or more flavorants.

In another separate aspect, the first water-soluble film comprises vitamin D₃, vitamin B₆, folic acid, vitamin B₁₂, iron and iodine.

In another separate aspect, the first water-soluble film comprises vitamin A, vitamin C, vitamin D, vitamin E, niacin, vitamin B₆, folic acid, vitamin B₁₂, iodine, iron, and choline.

In another separate aspect, the total amount of the one or more vitamins and minerals on the first water-soluble film is about 50 mg or less.

In another separate aspect, the total amount of the one or more vitamins and minerals on the first water-soluble film is about 30 mg or less.

In another separate aspect, the iron is encapsulated.

In another separate aspect, the folic acid is encapsulated.

In another separate aspect, one or more of the first or second water soluble films comprises one or a combination of polymers selected from the group consisting of pullulan, hydrocolloids, β-glucan, maltodextrin, celluloses, including hydroxypropyl methylcellulose, hydroxyethyl cellulose, hydroxypropyl cellulose, carboxymethyl cellulose, methylcellulose, hydroxymethylcellulose, hydroxyethylcellulose, polyvinyl pyrrolidone, polyvinyl alcohol, sodium alginate, polyethylene glycol, natural gums, such as locust bean gum, carrageenan gum, xanthan gum, tragacanth gum, guar gum, acacia gum, arabic gum, karaya, ghatti, tamarind gum, polyacrylic acid, methyl methacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein.

In another separate aspect, one or more of the first or second water-soluble films does not comprise an ingredient derived from animal sources.

In another separate aspect, one or more of the first or second water-soluble films consist of ingredients derived only from plant sources.

In another separate aspect, one or more of the first or second water-soluble films comprise at least one stabilizing agent, at least one coloring agent, water, at least one sweetening agent, and at least one cooling agent and at least one surfactant.

In one embodiment of the invention, a method is presented, the method comprising providing a kit as shown and described to a subject.

In one embodiment of the invention, a method for treating a pre-natal, pregnant, post-natal or breastfeeding subject for a nutritional deficiency is presented. The method comprises administering a first water-soluble film to the subject to treat the subject for nutritional deficiency, wherein the first water-soluble film is provided in a single homogenous mixture which is administered to the patient either buccally or sublingually.

In a separate aspect, the first water-soluble film comprises an effective amount of one or more vitamins and minerals selected from the group consisting of vitamin A, vitamin C, vitamin D₃, vitamin E, vitamin B₁, vitamin B₂, niacin, vitamin B₆, folic acid, vitamin B₁₂, iron, iodine, magnesium, zinc, and copper.

In a separate aspect, the first water-soluble film further comprises omega-3 fatty acids.

In a separate aspect, the omega-3 fatty acids is derived from algae.

In a separate aspect, the omega-3 fatty acids is provided on a second water-soluble film.

In a separate aspect, the one or more vitamins and minerals comprise iron, vitamin B₆, folic acid, and vitamin B₁₂.

In a separate aspect, the one or more vitamins and minerals comprise about 27 mg iron, about 2.5 mg vitamin B₆, about 1 mg folic acid, and about 12 mcg vitamin B₁₂.

In a separate aspect, the one or more vitamins comprise folic acid, vitamin D, vitamin B₆, vitamin B₁₂, wherein the first water-soluble film further comprises one or more flavorants.

In a separate aspect, the one of more vitamins and minerals comprise at least about 1 mg of folic acid, about 500 IU to about 2,000 IU of vitamin D, about 2 mg to about 5 mg of vitamin B₆, at least about 6 mcg to about 20 mcg of vitamin B₁₂, wherein the first water-soluble film further comprises at least about 0 mg to about 200 mg of the one or more flavorants.

In a separate aspect, the one or more vitamins and minerals comprise: vitamin D₃, vitamin B₆, folic acid, vitamin B₁₂, iron and iodine.

In a separate aspect, the one or more vitamins and minerals comprise vitamin A, vitamin C, vitamin D, vitamin E, niacin, vitamin B₆, folic acid, vitamin B₁₂, iodine, iron, and choline.

In a separate aspect, a total amount of the one or more vitamins and minerals on the first water-soluble film is about 50 mg or less.

In a separate aspect, the total amount is about 30 mg or less.

In another separate aspect, the iron is encapsulated.

In another separate aspect, the folic acid is encapsulated.

In a separate aspect, one or more of the first or second water soluble films comprises one or a combination of polymers selected from the group consisting of: pullulan, hydrocolloids, β-glucan, maltodextrin, celluloses, including hydroxypropyl methylcellulose, hydroxyethyl cellulose, hydroxypropyl cellulose, carboxymethyl cellulose, methylcellulose, hydroxymethylcellulose, hydroxyethylcellulose, polyvinyl pyrrolidone, polyvinyl alcohol, sodium alginate, polyethylene glycol, natural gums, such as locust bean gum, carrageenan gum, xanthan gum, tragacanth gum, guar gum, acacia gum, arabic gum, karaya, ghatti, tamarind gum, polyacrylic acid, methyl methacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein.

In another separate aspect, one or more of the first or second water-soluble films does not comprise an ingredient derived from animal sources.

In another separate aspect, one or more of the first or second water-soluble films consist of ingredients derived only from plant sources.

In another separate aspect, one or more of the first or second water-soluble films comprise at least one stabilizing agent, at least one coloring agent, water, at least one sweetening agent, and at least one cooling agent and at least one surfactant.

### DETAILED DESCRIPTION OF THE EXEMPLARY EMBODIMENTS

It is understood that the present invention is not limited to the particular methodologies, protocols, fillers, and excipients, etc., described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a vitamin” is a reference to one or more vitamins and includes equivalents thereof known to those skilled in the art and so forth.

Unless defined otherwise, all technical and scientific terms used herein have the same meanings as commonly understood by one of ordinary skill in the art to which this invention belongs. Specific methods, devices, and materials are described, although any methods and materials similar or equivalent to those described herein can be used in the practice or testing of the present invention. All references cited herein are incorporated by reference herein in their entirety.

The term “disease state” as used herein, may comprise any state in which one or more organs or components of an organism malfunction. The term “disease state” may refer to any deterioration of any component of a subject's body and specifically a human subject's body. The term “disease state” may refer to any deficiency of any compound necessary for the maintenance or function of any component of any organism. The term “disease state” may refer to any condition in which a body contains toxins, produced by microorganisms that infect the body or by body cells through faulty metabolism or absorbed from an external source. A “disease state” may also include adverse states caused by any diet, any virus, fungi or any bacteria. A “disease state” may also include disorders associated with pregnant females such as, for example, osteomalacia and preeclampsia, and disorders associated with a developing child such as, for example, neural tube defects and various fetal abnormalities. A “disease state” may also include any pulmonary disorder such as, for example, bronchitis, bronchiectasis, atelectasis, pneumonia, diseases caused by inorganic dusts, diseases caused by organic dusts, any pulmonary fibrosis, and pleurisy. A “disease state” may also include any hematological/oncological disorder such as, for example, anemia, hemophilia, leukemia, and lymphoma. A “disease state” may also include any cancer such as, for example, breast cancer, lung cancer, prostate cancer, pancreatic cancer, liver cancer, stomach cancer, testicular cancer, ovarian cancer, skin cancer, cancer of the brain, cancer of the mouth, cancer of the throat, and cancer of the neck. A “disease state” may also include any disorder of the immune system such as, for example, acquired immune deficiency syndrome (AIDS), AIDS-related complex, infection by any strain of any human immunodeficiency virus (HIV), and other viruses or pathogens such as bacteria, fungi and parasites. A “disease state” may also include any cardiovascular disorder such as, for example, arterial hypertension, orthostatic hypotension, arteriosclerosis, coronary artery disease, cardiomyopathy, any arrhythmia, any valvular heart disease, endocarditis, pericardial disease, any cardiac tumor, any aneurysm, and any peripheral vascular disorder. A “disease state” may also include any hepatic/biliary disorder such as, for example, jaundice, hepatic steatosis, fibrosis, cirrhosis, hepatitis, any hepatic granuloma, any liver tumor, cholelithiasis, cholecystitis, and choledocholithiasis. A “disease state” may also include a viral infection such as from HIV, herpes virus (HSV-1 and HSV-2), the virus that causes vesicular stomatitis (VSV), measles virus, herpes viridae, human lymphotropic viruses, vesicular stomatitis virus, visna virus, cytomegalovirus, Epstein-Barr virus, influenza virus, pneumonovirus, Sarcoma virus, Syncytial virus and Rubeola virus. A “disease state” may also include a fungal infection such as from Candida albicans and Giardia lamblia. A “disease state” may also include a bacterial infection such as from Staphylococcus, Corynebacerium, Bacillus, Listeria and Streptococcus bacteria, and include species such as Staphylococcus aureus, bacillus anthracis, Helicobacter pylori and, Listeria monocytogenes, and Streptococcus agalactiae.

The term “physiologically stressful state,” as used herein, comprises any state of an organism in which the organism faces one or more physiological challenges. A “physiologically stressful state” may comprise pregnancy, lactation, or conditions in which an organism faces physiological challenges related to, for example, elevated metabolic demand, increased plasma volume, or decreased concentrations of nutrient-binding proteins. A “physiologically stressful state” may result from one or more disease states.

The term “subject,” as used herein, comprises any and all organisms and includes the term “patient.” “Subject” may refer to a human or any other animal. “Subject” may also refer to a pre-natal, pregnant, post-natal, and/or breastfeeding or lactating woman. “Subject” may also refer to a developing child.

The phrase “co-administration” refers to administration of two or more compositions to a subject together, which includes administration at about the same time or within a certain specific or desired time.

The phrase “dissolvable form” refers to any compositions that dissolve into a solution in the mouth, such as, for example, buccally or sublingually. Such compositions, in one embodiment, may dissolve within about 60 seconds or less after placement in the mouth without any chewing.

The term “antioxidant” means an agent which inhibits oxidation and thus is used to prevent deterioration of preparations by the oxidative process. Such compounds include, by way of example and without limitation, ascorbic acid, ascorbyl palmitate, butylated hydroxyanisole, butylated hydroxytoluene, hypophosphorous acid, monothioglycerol, propyl gallate, sodium ascorbate, sodium bisulfite, sodium formaldehyde sulfoxylate and sodium metabisulfite and others known to those of ordinary skill in the art.

The phrase “pharmaceutically acceptable,” as used herein, refers to those compounds, materials, compositions and/or dosage forms which are, within the scope of sound pharmaceutical/medical judgment, suitable for use in contact with the tissues of human beings and animals without excessive toxicity, irritation, allergic response, or other problem or complication, commensurate with a reasonable benefit/risk ratio. Thus, the phrase “pharmaceutically acceptable carriers,” as used herein, refers to such suitable compounds and materials defined above that may be added to the dosage form to assist in satisfactory processing of the dosage form or provide desirable physical characteristics to the dosage form. For example, “pharmaceutically acceptable carriers” may include, but is not limited to, binders, diluents, lubricants, glidants, colorants, emulsifiers, disintegrants, starches, water, oils, alcohols, preservatives, and sugars. In another example, “pharmaceutically acceptable carriers” refers to dosage forms used with, for example, orally dissolvable compositions comprising or consisting of omega-3 fatty acids such DHA.

The term “dosage form,” as used herein, may be the form in which the dose is to be administered to the subject or patient. The drug or supplement is generally administered as part of a formulation that includes nonmedical agents. The dosage form has unique physical and pharmaceutical characteristics. Dosage forms, for example, may be solid, liquid or gaseous. “Dosage forms,” may include for example, a capsule, tablet, caplet, a soft shell capsule, such as a gel caplet (gel-cap), syrup, a liquid composition, a powder, a concentrated powder, a concentrated powder admixed with a liquid, a chewable form, a swallowable form, a dissolvable form, a water soluble film, an effervescent, a granulated form, and an oral liquid solution.

The term “substantially free of added” as used herein, means free from therapeutically effective amounts of compounds when administered in suggested doses, but may include trace amounts of compounds in non-therapeutically effective amounts. For example, one embodiment of a composition that included an inactive ingredient that is a salt or compound including a mineral would still be substantially free of added minerals. For example, trace amounts of titanium dioxide may be provided. Titanium dioxide which is an effective opacifier in powder form, where it is employed as a pigment to provide whiteness and opacity to numerous pharmaceutical products.

As used herein, the terms “inactive,” “inert,” “excipient,” and/or “formulatory” refer to any compound that is an inactive ingredient of a described composition. The definition of “inactive ingredient” as used herein follows that of the U.S. Food and Drug Administration, as defined in 21 C.F.R. § 201.3(b)(8), which is any component of a drug product other than the active ingredient.

The term “active ingredient,” then, includes any compound intended to furnish pharmacological activity or other direct effect in the diagnosis, cure, mitigation, treatment and/or prevention of disease or a condition. See 21 C.F.R. § 210.3(b)(7). Further, “active ingredients” include those compounds of the composition that may undergo chemical change during the manufacture of the composition and be present in the final composition in a modified form intended to furnish an activity or effect. Id. These include the vitamins, minerals and nutrients of the orally dissolvable compositions.

The term “administrable” defines a composition that is able to be given to a subject. Likewise, “administering” refers to the act of giving a composition to a subject or otherwise making such composition available to a subject or the subject taking a composition.

As used herein, the term “about,” when located before a dosage amount or dosage range of a specific ingredient, refers to an amount or range closely above and/or closely below the stated amount or range that does not manifestly alter the therapeutic effect of the specific ingredient from the stated amount or range and is meant to encompass at least all equivalents of that amount. Thus, the term “about” before a specific value may define a range from about the specific value minus at least 10% or at least 20% to the specific value plus at least 10% or at least 20% of the specific value. For example, “about 50” may define a range from 45 to 55 or a range from 40 to 60. See Ortho-McNeil Pharm., Inc. v. Caraco Pharm. Labs., Ltd., 476 F.3d 1321 (Fed. Cir. 2007).

The term “prenatal” supplementation includes optimizing specific nutrients before (pre-pregnancy), during, and after the physiological processes of pregnancy and lactation, which can have profound, positive, and comprehensive impacts on the overall wellness of the developing child as well as on the safety and health of the subject.

Proper nutrition is essential for maintaining health and preventing diseases. Adequate nutrition is especially critical during, for example, nutritionally volatile or physiologically stressful periods such as those including, by way of example and without limitation, pregnancy, lactation, or any disease state. Vitamin and mineral needs are almost universally increased throughout these periods. Increased needs during physiologically stressful states such as pregnancy, lactation or disease state may result from elevated metabolic demand, increased plasma volume, increased quantities of circulating red blood cells, decreased concentrations of nutrients, and decreased concentrations of nutrient-binding proteins such as, for example and without limitation, serum-ferritin, maltose-binding protein, lactoferrin, calmodulin, tocopheryl binding protein, riboflavin binding protein, retinol binding protein, transthyretin, high density lipoprotein-apolipoprotein A1, folic acid binding protein, and 25-hydroxyvitamin D binding protein. Lapido, 72 (Supp.) AMER. J. CLIN. NUTR. 280S-90S (2000).

Optimizing specific nutrients before, during, and after the physiological processes of pregnancy and lactation can have profound, positive, and comprehensive impacts on the overall wellness of the developing child as well as on the safety and health of the pregnant woman. Black, 85 (Supp.) BRIT. J. NUTR. S193-97 (2001); Scholl et al., 146 AMER. J. EPIDEM. 134-41 (1997). Nutrients provided to a pregnant woman reach the developing child. Specifically, it is established that substrates for growth and development, for example, circulate within the same pathways that carry drugs to and waste products from the developing child. Exchanges of material between the pregnant woman and developing child occur primarily in the placenta, where villi containing fetal capillaries protrude into sinuses (intervillous spaces). Maternal arterial blood spurts into these spaces, then drains into maternal uterine veins to be returned to the maternal systemic circulation. Solutes in maternal blood cross the epithelial cells and connective tissue of the villi and the endothelium of the fetal capillaries; these solutes are then carried to the developing child by placental veins, which converge into the umbilical vein. THE MERCK MANUAL OF DIAGNOSIS AND THERAPY (19th ed. 2011). The orally dissolvable composition disclosed herein may thus provide the means to optimize good health by utilizing vitamin, mineral, and nutritional supplementation. The compositions disclosed herein may be administered to or directed to a subject such as a human or any other organism.

The orally dissolvable compositions disclosed herein may include vitamin A. Vitamin A is involved in physiological processes that result in cellular differentiation, cellular maturity, and cellular specificity. Thus, vitamin A is an important component of a nutritional supplement for subjects in physiologically stressful states, such as those caused by pregnancy, lactation or disease state. Zile et al., 131(3) J. NUTR. 705-08 (2001). Care should be taken, however, to avoid excess. Indeed, supplemental vitamin A ingestion during pregnancy has been shown in some studies to be teratogenic or deforming to human and animal embryos. GB Mulder et al., 62(4) TERATOLOGY 214-26 (2000). In one embodiment, vitamin A may be in a form that is a precursor (pro-vitamin) or metabolite of vitamin A that provides similar nutritional value as vitamin A. For example, the pro-vitamin A carotenoid, may be beta carotene. Beta carotene is converted to other forms of vitamin A, specifically retinol, within the body as needed, thereby avoiding the risk of retinol toxicity. Mayne, FASEB J 10:690-701 (1996). In a specific embodiment, vitamin A may be in one or more of the forms of retinol acetate (also known as retinyl acetate or vitamin A acetate), retinol (vitamin A alcohol), retinol palmitate (also known as retinyl palmitate or vitamin A palmitate), retinoic acid (tretinoin), retinal, beta-cryptoxanthin, alpha-carotene, beta-carotene, gamma-carotene, and provitamin A carotenoids.

In a specific embodiment, vitamin A may be in the form of beta carotene as beta carotene also has powerful anti-oxidant properties. Antioxidants are important during physiologically stressful events for numerous reasons. For example, lipid peroxidation has been associated with over 200 disease processes. Rock et al., 96(7) J. AMER. DIET. ASSOC. 693-702 (1996). Antioxidants are especially important during pregnancy because in the first trimester, establishment of blood flow into the intervillous space is associated with a burst of oxidative stress. The inability to mount an effective antioxidant defense against this burst results in early pregnancy loss. Myatt & Cui, 122, HISTOCHEM. CELL BIOL., 369-82 (2004). Further, oxidative stress has been implicated in the pathophysiology of preeclampsia, a toxemia of pregnancy. Llurba et al., 37(4) FREE RADIC. BIOL. MED. 557-70 (2004). Finally, oxidative stress during pregnancy plays an important role in fetal growth, and healthy antioxidant levels are positively correlated with birth weight and length. Myatt & Cui; Lee et al., 58 EUR. J. CLIN. NUTR., 481-87 (2004).

In a specific embodiment of the orally dissolvable compositions of the present invention, vitamin A may be included in amounts ranging from about 550 IU to about 1650 IU. In another specific embodiment, vitamin A may be included in amounts ranging from about 880 IU to about 1320 IU. In another specific embodiment, vitamin A may be included in amounts ranging from about 990 IU to about 1210 IU. In another embodiment, vitamin A may be included in an amount of about 1100 IU.

In another specific embodiment, vitamin A may be included in specific ranges or amounts for each specific form. When provided in their specific forms, the provided numerical range or amount includes the amounts of the specific form and/or compounds that are equivalent to the specific form. For example, vitamin A may be in a form that is a precursor (pro-vitamin) or metabolite of vitamin A that provides or produces similar nutritional value as vitamin A. See Composition of Foods Raw, Processed, Prepared, U.S. Department of Agriculture, Agricultural Research Service, USDA National Nutrient Database for Standard Reference, Release 26 (2013). In embodiments of the invention, this form may be optimized to extend or maximize availability in the subject. Vitamin A may be in the form of beta carotene and may be included in the amount of about 1100 IU. Accordingly, in this example, “beta carotene in the amount of about 1100 IU” would include 1000 IU of beta carotene and/or its equivalents and would, for example, include a product having 1100 IU retinol acetate instead of beta carotene.

In another specific embodiment of the orally dissolvable compositions, vitamin A in the form of beta carotene may be included in amounts ranging from about 550 IU to about 1650 IU. In another specific embodiment, vitamin A in the form of beta carotene may be included in amounts ranging from about 880 IU to about 1320 IU. In another specific embodiment, vitamin A in the form of beta carotene may be included in amounts ranging from about 990 IU to about 1210 IU. In another embodiment, vitamin A in the form of beta carotene may be included in an amount of about 1100 IU. In another specific embodiment of the orally dissolvable compositions, vitamin A may be included in the form of beta carotene and one or more forms of vitamin A. In a specific embodiment, the orally dissolvable compositions may include beta carotene and retinol. In another embodiment, the orally dissolvable compositions may include beta carotene and retinol acetate.

In another embodiment, vitamin A may be present in an amount determined by a measure of mass, as opposed to IUs. One IU of vitamin A is defined as the biological equivalent of about 0.6 μg of beta carotene, or about 0.3 μg of retinol. See REMINGTON, THE SCIENCE AND PRACTICE OF PHARMACY (22^{th} ed. 2012). Accordingly, 550 IU to about 1650 IU is the biological equivalent of about 330 μg to about 990 μg. In another example, about 880 IU to about 1320 IU is the biological equivalent of about 528 μg to about 792 μg. In another example, about 990 IU to about 1210 IU is the biological equivalent of about 594 μg to about 726 μg. In another example, 1100 IU is the biological equivalent of about 660 μg.

In a further embodiment, vitamin A may be present in the nutritional composition in any one or a combination of the forms disclosed herein in an amount of at least about 500 IU, at least about 550 IU, at least about 600 IU, at least about 650 IU, at least about 700 IU, at least about 750 IU, at least about 800 IU, at least about 850 IU, at least about 900 IU, at least about 950 IU, at least about 1000 IU, at least about 1050 IU, at least about 1100 IU, at least about 1150 IU, at least about 1200 IU, at least about 1250 IU, at least about 1300 IU, at least about 1350 IU, at least about 1400 IU, at least about 1450 IU, at least about 1500 IU, at least about 1550 IU, at least about 1600 IU, at least about 1650 IU, at least about 1700 IU, at least about 1750 IU, at least about 1800 IU, at least about 1850 IU, at least about 1900 IU, at least about 1950 IU, at least about 2000 IU, at least about 2050 IU, at least about 2100 IU, at least about 2150 IU, at least about 2200 IU, at least about 2250 IU, at least about 2300 IU, at least about 2350 IU, at least about 2400 IU, at least about 2450 IU and at least about 2500 IU. Vitamin A may be present in the nutritional composition in a range of between and including any two of the foregoing values. In embodiments where vitamin A is present in a combination of forms, each constituent form may be present in a relative amount of about 10%, about 20%, about 30%, about 40%, about 50%, about 60%, about 70%, about 80%, about 90% of any one of the foregoing amounts for vitamin A.

The orally dissolvable compositions may comprise or use one or more B-complex vitamins. This class of vitamins comprises water-soluble nutrients generally not stored in the body. They play roles in a variety of biological processes critical to the health of pregnant women, lactating women, and developing children such as, for example, the metabolism of homocysteine. The B-complex vitamins that may be included in the orally dissolvable compositions comprise one or more of vitamin B₁, vitamin B₂, vitamin B₃, vitamin B₆, vitamin B₉ and vitamin B₁₂.

The orally dissolvable compositions may comprise or use vitamin B₁Vitamin B₁ plays a role in carbohydrate metabolism and neural function. It is a coenzyme for the oxidative decarboxylation of alpha-keto acids (e.g., alpha-ketoglutarate and pyruvate) and for transketolase, which is a component of the pentose phosphate pathway. NATIONAL RESEARCH COUNCIL, RECOMMENDED DIETARY ALLOWANCES, page 125 (10th ed. 1989) (hereinafter “RDA”). In another specific embodiment, vitamin B₁ may be in one or more of the forms of thiamine, thiamine monophosphate, thiamine diphosphate, thiamine triphosphate, acetiamine, allithiamine, prosultiamine and S-acyl derivatives of thiamine such as benfotiamine, fursultiamine and salts and esters thereof.

In another specific embodiment, vitamin B₁ may be included in amounts ranging from about 0.8 mg to about 2.4 mg. In another specific embodiment, vitamin B₁ may be included in amounts ranging from about 1.3 mg to about 1.9 mg. In another specific embodiment, vitamin B₁ may be included in amounts ranging from about 1.4 mg to about 1.75 mg. In another embodiment, vitamin B₁ may be included in an amount of about 1.6 mg.

In another specific embodiment, vitamin B₁ may be included in specific ranges or amounts for each specific form. When provided in their specific forms, the provided numerical range or amount includes the amounts of the specific form and/or compounds that are equivalent to the specific form. For example, vitamin B₁ may be in the form of thiamine mononitrate and may be included in the amount of about 1.6 mg. Accordingly, in this example, “thiamine mononitrate in the amount of about 1.6 mg ” would include 1.6 mg of thiamine mononitrate and/or its equivalents and would, for example, include a product having 1.6 mg allithiamine instead of thiamine mononitrate.

In a further embodiment, vitamin B₁ may be present in the nutritional composition in any one or a combination of forms disclosed herein an amount of at least about 0.5 mg, at least about 0.6 mg, at least about 0.7 mg, at least about 0.8 mg, at least about 0.9 mg, at least about 1.0 mg, at least about 1.1 mg, at least about 1.2 mg, at least about 1.3 mg, at least about 1.4 mg, at least about 1.5 mg, at least about 1.6 mg, at least about 1.7 mg, at least about 1.8 mg, at least about 1.9 mg, at least about 2.0 mg, at least about 2.1 mg, at least about 2.2 mg, at least about 2.3 mg, at least about 2.4 mg, at least about 2.5 mg, at least about 2.6 mg, at least about 2.7 mg, at least about 2.8 mg, at least about 2.9 mg, and at least about 3.0 mg. Vitamin Bi may be present in the nutritional composition in a range of between and including any two of the foregoing values. In embodiments where vitamin B₁ is present in a combination of forms, each constituent form may be present in a relative amount of about 10%, about 20%, about 30%, about 40%, about 50%, about 60%, about 70%, about 80%, about 90% of any one of the foregoing amounts for vitamin B₁.

The orally dissolvable compositions of the present invention may comprise or use vitamin B₂. Vitamin B₂ is a component of two flavin coenzymes, flavin mononucleotide (FMN) and flavin adenine dinucleotide (FAD). These flavoenzymes are involved in a number of oxidation-reduction reactions including the conversion of pyridoxine and niacin. RDA, supra at 132. Flavoenzymes also play a role in a number of metabolic pathways such as amino acid deamination, purine degradation and fatty acid oxidation and thus help to maintain carbohydrate, amino acid and lipid metabolism.

In a specific embodiment, vitamin B₂ may be in one or more of the forms of flavin mononucleotide (FMN), flavin adenine dinucleotide (FAD), riboflavin (also known as 7,8-dimethyl- 10-((2R,3R,4S)- 2,3,4,5-tetrahydroxypentyl) benzo [g] pteridine- 2,4 (3H,10H)-dione or lactoflavin) and riboflavin derivatives such as riboflavin-5′-monophosphate, riboflavin-5′-monobutyrate and riboflavin-5′-monopalmitate. In a specific embodiment, vitamin B₂ may be included in the form of riboflavin.

In another specific embodiment, vitamin B₂ may be included in amounts ranging from about 0.9 mg to about 2.7 mg. In another specific embodiment, vitamin B₂ may be included in amounts ranging from about 1.5 mg to about 2.2 mg. In another specific embodiment, vitamin B₂ may be included in amounts ranging from about 1.6 mg to about 2 mg. In another embodiment, vitamin B₂ may be included in an amount of about 1.8 mg.

In another specific embodiment, vitamin B₂ in the form of riboflavin may be included in amounts ranging from about 0.9 mg to about 2.7 mg. In another specific embodiment, vitamin B₂ in the form of riboflavin may be included in amounts ranging from about 1.5 mg to about 2.2 mg. In another specific embodiment, vitamin B₂ in the form of riboflavin may be included in amounts ranging from about 1.6 mg to about 2 mg. In another embodiment, vitamin B₂ in the form of riboflavin may be included in an amount of about 1.8 mg.

In another specific embodiment, vitamin B₂ may be included in specific ranges or amounts for each specific form. When provided in their specific forms, the provided numerical range or amount includes the amounts of the specific form and/or compounds that are equivalent to the specific form. For example, vitamin B₂ may be in the form of riboflavin and may be included in the amount of about 1.8 mg. Accordingly, in this example, “riboflavin in the amount of about 1.8 mg” would include 1.8 mg of riboflavin and/or its equivalents and would, for example, include a product having 1.8 mg flavin mononucleotide instead of riboflavin.

In a further embodiment, vitamin B₂ may be present in the nutritional composition in any one or a combination of forms disclosed herein an amount of at least about 0.5 mg, at least about 0.6 mg, at least about 0.7 mg, at least about 0.8 mg, at least about 0.9 mg, at least about 1.0 mg, at least about 1.1 mg, at least about 1.2 mg, at least about 1.3 mg, at least about 1.4 mg, at least about 1.5 mg, at least about 1.6 mg, at least about 1.7 mg, at least about 1.8 mg, at least about 1.9 mg, at least about 2.0 mg, at least about 2.1 mg, at least about 2.2 mg, at least about 2.3 mg, at least about 2.4 mg, at least about 2.5 mg, at least about 2.6 mg, at least about 2.7 mg, at least about 2.8 mg, at least about 2.9 mg, at least about 3.0 mg, at least about 3.1 mg, at least about 3.2 mg, at least about 3.3 mg, at least about 3.4 mg, and at least about 3.5 mg. Vitamin B₂ may be present in the nutritional composition in a range of between and including any two of the foregoing values. In embodiments where vitamin B₂ is present in a combination of forms, each constituent form may be present in a relative amount of about 10%, about 20%, about 30%, about 40%, about 50%, about 60%, about 70%, about 80%, about 90% of any one of the foregoing amounts for vitamin B₂.

The orally dissolvable compositions may comprise or use vitamin B₃. Vitamin B₃, or “niacin” is the common name for two compounds: nicotinic acid (also called niacin) and niacinamide (also called nicotinamide). Vitamin B₃ is particularly important for maintaining healthy levels and types of fatty acids. It is also required for the synthesis of pyroxidine, riboflavin, and folic acid. RDA, supra at 137. Administration of vitamin B₃ also may effect a reduction in total cholesterol (LDL) and very low density lipoprotein (VLDL) levels and an increase in high density lipoprotein (HDL) cholesterol levels. Nicotinamide adenine dinucleotide (NAD) and NAD phosphate (NADP) are active coenzymes of niacin. These coenzymes are involved in numerous enzymatic reactions such as glycolysis, fatty acid metabolism, and steroid synthesis. Henkin et al., 91 AM. J. MED. 239-46 (1991). In a specific embodiment, vitamin B₃ may in the forms of niacin (nicotinic acid or pyridine-3-carboxylic acid), and nicotinamide (niacinamide) and salts and esters thereof. In a specific embodiment, vitamin B₃ may be included in the form of nicotinamide. In another specific embodiment, an equivalent molar amount of niacin may be included.

In another specific embodiment, vitamin B₃ may be included in amounts ranging from about 7.5 mg to about 22.5 mg. In another specific embodiment, vitamin B₃ may be included in amounts ranging from about 12 mg to about 18 mg. In another specific embodiment, vitamin B₃ may be included in amounts ranging from about 13.5 mg to about 16.5 mg. In another embodiment, vitamin B₃ may be included in an amount of about 15 mg.

In another specific embodiment, vitamin B₃ may be included in specific ranges or amounts for each specific form. When provided in their specific forms, the provided numerical range or amount includes the amounts of the specific form and/or compounds that are equivalent to the specific form. For example, vitamin B₃ may be in the form of nicotinamide and may be included in the amount of about 15 mg. Accordingly, in this example, “nicotinamide in the amount of about 15 mg” would include 15 mg of nicotinamide and/or its equivalents and would, for example, include a product having 15 mg niacin instead of nicotinamide.

In another specific embodiment, vitamin B₃ in the form of nicotinamide may be included in amounts ranging from about 7.5 mg to about 22.5 mg. In another specific embodiment, vitamin B₃ in the form of nicotinamide may be included in amounts ranging from about 12 mg to about 18 mg. In another specific embodiment, vitamin B₃ in the form of nicotinamide may be included in amounts ranging from about 13.5 mg to about 16.5 mg. In another embodiment, vitamin B₃ in the form of nicotinamide may be included in an amount of about 15 mg.

In a further embodiment, vitamin B₃ may be present in the nutritional composition in any one or a combination of forms disclosed herein an amount of at least about 5 mg, at least about 5.5 mg, at least about 6 mg, at least about 6.5 mg, at least about 7 mg, at least about 7.5 mg, at least about 8 mg, at least about 8.5 mg, at least about 9 mg, at least about 9.5 mg, at least about 10 mg, at least about 10.5 mg, at least about 11 mg, at least about 11.5 mg, at least about 12 mg, at least about 12.5 mg, at least about 13 mg, at least about 13.5 mg, at least about 14 mg, at least about 14.5 mg, at least about 15 mg, at least about 15.5 mg, at least about 16 mg, at least about 16.5 mg, at least about 17 mg, at least about 17.5 mg, at least about 18 mg, at least about 18.5 mg, at least about 19 mg, at least about 19.5 mg, at least about 20 mg, at least about 20.5 mg, at least about 21 mg, at least about 21.5 mg, at least about 22 mg, at least about 22.5 mg, at least about 23 mg, at least about 23.5 mg, at least about 24 mg, at least about 24.5 mg, and at least about 25 mg. Vitamin B₃ may be present in the nutritional composition in a range of between and including any two of the foregoing values. In embodiments where vitamin B₃ is present in a combination of forms, each constituent form may be present in a relative amount of about 10%, about 20%, about 30%, about 40%, about 50%, about 60%, about 70%, about 80%, about 90% of any one of the foregoing amounts for vitamin B₃.

The orally dissolvable compositions may comprise or use vitamin B₆. The administration of vitamin B₆ may reduce the levels of homocysteine. Bostom et al., 49 KIDNEY INT. 147-52 (1996). The active forms of vitamin B₆, pyridoxal-5′-phosphate (PLP) and pyridoxamine-5′-phosphate, are coenzymes for numerous enzymes and as such, are important for gluconeogenesis, niacin formation, and erythrocyte metabolism. RDA, supra at 142-43. Vitamin B₆ is a coenzyme for both cystathionine synthase and cystathionase, enzymes that catalyze the formation of cysteine from methionine. Homocysteine is an intermediate in this process and elevated levels of plasma homocysteine are recognized as a risk factor for both vascular disease (Robinson et al., 94 CIRCULATION 2743-48 (1996)) and neural tube defects (Locksmith & Duff, 91 OBSTET. GYNECOL. 1027-34 (1998)). In a specific embodiment, vitamin B₆ may be included in the forms of pyridoxine, 3-hydroxy-4,5-bis(hydroxymethyl)2-methylpyridine, 5′-deoxypyridoxal, 2-demethylpyridoxal(2-norpyridoxal), 2-propyl-2-norpyridoxal (2′-ethylpyridoxal), 6-methylpyridoxal, 2′-hydroxypyridoxal (2-hydroxymethyl-2-demethylpyridoxal or 2-hydroxymethyl-2-norpyridoxal), 4′-deoxypyridoxine 5′-phosphate, 5′-methylpyridoxal-5′-phosphate, pyridoxal N-oxide 5′-phosphate, Pyridoxal, Pyridoxamine, Pyridoxine-5′-phosphate (PNP), pyridoxal-5′-phosphate (PLP) and pyridoxamine-5′-phosphate (PMP), and their salts and chelates thereof. In a specific embodiment, vitamin B₆ may be included in the form of pyridoxine hydrochloride.

In another specific embodiment, vitamin B₆ may be included in specific ranges or amounts for each specific form. When provided in their specific forms, the provided numerical range or amount includes the amounts of the specific form and/or compounds that are equivalent to the specific form. For example, vitamin B₆ may be in the form of pyridoxine hydrochloride and may be included in the amount of about 2.5 mg. Accordingly, in this example, “pyridoxine hydrochloride in the amount of about 2.5 mg” would include 2.5 mg of pyridoxine hydrochloride and/or its equivalents and would, for example, include a product having 2.5 mg pyridoxamine instead of pyridoxine hydrochloride.

In another specific embodiment, vitamin B₆ may be included in amounts ranging from about 1.2 mg to about 3.8 mg. In another specific embodiment, vitamin B₆ may be included in amounts ranging from about 2.0 mg to about 3.0 mg. In another specific embodiment, vitamin B₆ may be included in amounts ranging from about 2.25 mg to about 2.75 mg. In another embodiment, vitamin B₆ may be included in an amount of about 2.5 mg.

In a further embodiment, vitamin B₆ may be present in the nutritional composition in any one or a combination of forms disclosed herein an amount of at least about 1 mg, at least about 1.1 mg, at least about 1.2 mg, at least about 1.3 mg, at least about 1.4 mg, at least about 1.5 mg, at least about 1.6 mg, at least about 1.7 mg, at least about 1.8 mg, at least about 1.9 mg, at least about 2 mg, at least about 2.1 mg, at least about 2.2 mg, at least about 2.3 mg, at least about 2.4 mg, at least about 2.5 mg, at least about 2.6 mg, at least about 2.7 mg, at least about 2.8 mg, at least about 2.9 mg, at least about 3 mg, at least about 3.1 mg, at least about 3.2 mg, at least about 3.3 mg, at least about 3.4 mg, at least about 3.5 mg, at least about 3.6 mg, at least about 3.7 mg, at least about 3.8 mg, at least about 3.9 mg, at least about 4.0 mg, at least about 4.1 mg, at least about 4.2 mg, at least about 4.3 mg, at least about 4.4 mg, and at least about 4.5 mg. Vitamin B₆ may be present in the nutritional composition in a range of between and including any two of the foregoing values. In embodiments where vitamin B₆ is present in a combination of forms, each constituent form may be present in a relative amount of about 10%, about 20%, about 30%, about 40%, about 50%, about 60%, about 70%, about 80%, about 90% of any one of the foregoing amounts for vitamin B₆.

The orally dissolvable compositions may comprise or use vitamin B₉. Vitamin B₉ is a generic name of a B-vitamin that includes multiple compounds with a general structure. For example, vitamin B₉ encompasses the term folate, which itself is the generic name for many different forms of this water-soluble vitamin (vitamin B9), which is essential for DNA synthesis and, hence, cell division. Simpson et al., THE JOURNAL OF MATERNAL-FETAL AND NEONATAL MEDICINE, Micronutrients and women of reproductive potential: required dietary intake and consequences of dietary deficiency or excess. Part I—Folate, Vitamin B₁₂, Vitamin B₆, Epub 1-21, (2010). Indeed, folate encompasses numerous compounds that for example, are based on a pteridine ring, an aminobenzoic acid and one or more glutamic acid residues. Id. Folic acid (pteroglutamic acid or PGA) is a synthetic form of folate, and the first folate synthesized and used as a supplement. Id. The term folates may also be used in the generic sense to designate any members of the family of pteroylglutamates, or mixtures of them, having various levels of reduction of the pteridine ring, one-carbon substitutions and numbers of glutamate residues. PURE & APPL. CHEM., IUPAC-IUB Commission on Biochemical Nomenclature (CBN). Nomenclature and Symbols for Folic Acid and Related Compounds. Arch 59, No. 6: 833-836 (1987).

Vitamin B₉, however, is not only defined by its structure, but also by its various functions. Indeed, vitamin B₉ is essential for DNA synthesis and, hence, cell division and is required metabolically as a coenzyme in one-carbon transfer reactions. Simpson, supra. This vitamin has demonstrated the ability to prevent neural tube defects such as spina bifida caused by disturbed homocysteine metabolism. Vanderput et al., EXP. BIOL. MED. 243-70 (2001); DeFalco et al., 27 CLIN. EXP. OBSTET. GYNECOL. 188-90 (2000); Eskes, 27 CLIN. EXP. OBSTET. GYNECOL. 157-67 (2000); Locksmith & Duff, supra. Folic acid, a commonly used term synonymous with vitamin B₉, is known to reduce the risk of multiple diseases. Clinical trials definitively demonstrated the effectiveness of folic acid supplementation in reducing the number of neural tube defects. Simpson et al., THE JOURNAL OF MATERNAL-FETAL AND NEONATAL MEDICINE, Micronutrients and women of reproductive potential: required dietary intake and consequences of dietary deficiency or excess. Part I—Folate, Vitamin B₁₂, Vitamin B₆, Epub 1-21, (2010). Indeed, folic acid supplementation in reducing the risk of neural tube defects and other congenital malformations is generally accepted. Pietrzik et al., CLIN PHARMACOKINET 49 (8): 535-548 (2010). Furthermore, evidence is accumulating to support a possible role of folic acid in the reduction in risk of other diseases, including dementia and certain types of cancer. Id. Lastly, folate or folate derivative thereof that increase blood folate levels, thereby reducing homocysteine levels, which is a common way to measure vitamin B₉ effectiveness. Id.

Thus, in a specific embodiment, vitamin B₉ may include numerous forms. In a specific embodiment, vitamin B₉ may be included in the form of folic acid. In another embodiment, vitamin B₉ may be included one or more of the forms of folic acid, folacin, metafolin, folate and/or one or more natural isomers of folate including (6S)-tetrahydrofolic acid or a polyglutamyl derivative thereof, 5-methyl-(6S)-tetrahydrofolic acid or a polyglutamyl derivative thereof, 5-formyl-(6S)-tetrahydrofolic acid or a polyglutamyl derivative thereof, 10-formyl-(6R)-tetrahydrofolic acid or a polyglutamyl derivative thereof, 5,10-methylene-(6R)-tetrahydrofolic acid or a polyglutamyl derivative thereof, 5,10-methenyl-(6R)-tetrahydrofolic acid or a polyglutamyl derivative thereof and 5-formimino-(6S)-tetrahydrofolic acid or a polyglutamyl derivative thereof and the salts and esters thereof. In another embodiment, vitamin B₉ may be in the form of a folate or folate derivative thereof that is eventually converted to 5-methyl-tetrahydrofolic acid in the body and/or is absorbed into the bloodstream as 5-methyl-tetrahydrofolic acid. Folates, such as folic acid and folate, are eventually absorbed in the body and converted to L-5-methyl-tetrahydrofolic acid In another embodiment, vitamin B₉ may be in the form of a folate or folate derivative thereof that increases blood folate levels, thereby reducing homocysteine levels.

In another embodiment, vitamin B₉ may be in the form of folate or reduced folates with various salts. In a specific embodiment, the folate and reduced folate are selected from the group consisting of D-glucosamine-folate, D-galactosamine- folate, D-glucosamine (6R, S) -tetrahydrofolate, D-glucosamine (6S) -tetrahydrofolate, D-glucosamine (6R) -tetrahydrofolate; D-galactosamine (6R, S) -tetrahydrofolate, D-galactosamine (6S)-tetrahydrofolate, D-galactosamine (6R) -tetrahydrofolate; D-glucosamine 5-methyl- (6R, S)-tetrahydrofolate, D-glucosamine 5-methyl- (6S) -tetrahydrofolate, D-glucosamine 5-methyl-(6R)-tetrahydrofolate; D-galactosamine 5-methyl- (6R, S)-tetrahydrofolate, D-galactosamine 5-methyl- (6S)-tetrahydrofolate, and D-galactosamine 5-methyl- (6R)-tetrahydrofolate.

In another specific embodiment, vitamin B₉ may be included in amounts ranging from about 0.5 mg to about 1.5 mg. In another specific embodiment, vitamin B₉ may be included in amounts ranging from about 0.8 mg to about 1.2 mg. In another specific embodiment, vitamin B₉ may be included in amounts ranging from about 0.9 mg to about 1.1 mg. In another embodiment, vitamin B₉ may be included in an amount of about 1.0 mg.

In another specific embodiment, vitamin B₉ may be included in specific ranges or amounts for each specific form. When provided in their specific forms, the provided numerical range or amount includes the amounts of the specific form and/or compounds that are equivalent to the specific form. For example, vitamin B₉ may be in the form folic acid and may be included in the amount of about 1.0 mg. Accordingly, in this example, “folic acid in the amount of about 1.0 mg” would include 1.0 mg of folic acid and/or its equivalents and would, for example, include a product having 1.0 mg 5-methyl-(6S)-tetrahydrofolic acid instead of folic acid.

In a specific embodiment, vitamin B₉ may be in the form of folic acid. In another specific embodiment, vitamin B₉ in the form of folic acid may be included in amounts ranging from about 0.5 mg to about 1.5 mg. In another specific embodiment, vitamin B₉ in the form of folic acid may be included in amounts ranging from about 0.8 mg to about 1.2 mg. In another specific embodiment, vitamin B₉ in the form of folic acid may be included in amounts ranging from about 0.9 mg to about 1.1 mg. In another embodiment, vitamin B₉ in the form of folic acid may be included in an amount of about 1.0 mg.

In a further embodiment, vitamin B₉ may be present in the nutritional composition in any one or a combination of forms disclosed herein an amount of at least about 0.5 mg, at least about 0.6 mg, at least about 0.7 mg, at least about 0.8 mg, at least about 0.9 mg, at least about 1.0 mg, at least about 1.1 mg, at least about 1.2 mg, at least about 1.3 mg, at least about 1.4 mg, at least about 1.5 mg, at least about 1.6 mg, at least about 1.7 mg, at least about 1.8 mg, at least about 1.9 mg, at least about 2.0 mg, at least about 2.1 mg, at least about 2.2 mg, at least about 2.3 mg, at least about 2.4 mg, at least about 2.5 mg, at least about 2.6 mg, at least about 2.7 mg, at least about 2.8 mg, at least about 2.9 mg, at least about 3.0 mg, at least about 3.1 mg, at least about 3.2 mg, at least about 3.3 mg, at least about 3.4 mg, and at least about 3.5 mg. Vitamin B₉ may be present in the nutritional composition in a range of between and including any two of the foregoing values. In embodiments where vitamin B₉ is present in a combination of forms, for example folic acid and L-methylfolate calcium, each constituent form may be present in a relative amount of about 10%, about 20%, about 30%, about 40%, about 50%, about 60%, about 70%, about 80%, about 90% of any one of the foregoing amounts for vitamin B9. In one specific embodiment, for example, vitamin B₉ may be provided in an amount of 0.4 mg folic acid and 0.6 mg L-methylfolate calcium.

The orally dissolvable compositions may comprise or use vitamin B₁₂. Vitamin B₁₂ can be converted to the active coenzymes, methylcobalamin and 5′-deoxyadenosylcobalamin. These coenzymes are necessary for folic acid metabolism, conversion of coenzyme A and myelin synthesis. Methylcobalamin also catalyzes the demethylation of a folate cofactor which is involved in DNA synthesis. A lack of demethylation may result in folic acid deficiency. RDA, supra at 159-160. Deoxyadenosylcobalamin is the coenzyme for the conversion of methylmalonyl-CoA to succinyl-CoA, which plays a role in the citric acid cycle. Cobalamin, along with pyridoxine and folic acid, also are implicated in the proper metabolism of homocysteine, a breakdown product of the amino acid methionine, which is correlated with an increased risk of heart disease due to its negative effects on endothelial function. In a specific embodiment, vitamin B₁₂ may be in one or more of the forms of cobalamin, methylcobalamin, 5′-deoxyadenosylcobalamin (adenosylcobalamin or cobamamide), cyanocobalamin, hydroxycobalamin and mecobalamin.

In another specific embodiment, vitamin B₁₂ may be included in amounts ranging from about 6 μg to about 18 μg. In another specific embodiment, vitamin B₁₂ may be included in amounts ranging from about 9.6 μg to about 14.4 μg. In another specific embodiment, vitamin B₁₂ may be included in amounts ranging from about 10.8 μg to about 13.2 μg. In another embodiment, vitamin B₁₂ may be included in an amount of about 12 μg.

In another specific embodiment, vitamin B₁₂ may be included in specific ranges or amounts for each specific form. When provided in their specific forms, the provided numerical range or amount includes the amounts of the specific form and/or compounds that are equivalent to the specific form. For example, vitamin B₁₂ may be in the form cyanocobalamin and may be included in the amount of about 12 μg. Accordingly, in this example, “cyanocobalamin in the amount of about 12 μg” would include 12 μg of cyanocobalamin and/or its equivalents and would, for example, include a product having 12 μg methylcobalamin instead of cyanocobalamin.

In a further embodiment, vitamin B₁₂ may be present in the nutritional composition in any one or a combination of forms disclosed herein an amount of at least about 1 mg, at least about 5 μg, at least about 5.5 μg, at least about 6 μg, at least about 6.5 μg, at least about 7 μg, at least about 7.5 μg, at least about 8 μg, at least about 8.5 μg, at least about 9 μg, at least about 9.5 μg, at least about 10 μg, at least about 10.5 μg, at least about 11 μg, at least about 11.5 μg, at least about 12 μg, at least about 12.5 μg, at least about 13 μg, at least about 13.5 μg, at least about 14 μg, at least about 14.5 μg, at least about 15 μg, at least about 15.5 μg, at least about 16 μg, at least about 16.5 μg, at least about 17 μg, at least about 17.5 μg, at least about 18 μg, at least about 18.5 μg, at least about 19 μg, at least about 19.5 μg, and at least about 20 μg. Vitamin B₁₂ may be present in the nutritional composition in a range of between and including any two of the foregoing values. In embodiments where vitamin B₁₂ is present in a combination of forms, each constituent form may be present in a relative amount of about 10%, about 20%, about 30%, about 40%, about 50%, about 60%, about 70%, about 80%, about 90% of any one of the foregoing amounts for vitamin B₁₂.

The orally dissolvable compositions may comprise or use vitamin C. The major biochemical role of water-soluble vitamin C is as a co-substrate in metal catalyzed hydroxylations. Like beta carotene, vitamin C has antioxidant properties. It interacts directly with superoxide hydroxyl radicals and singlet oxygen, and also provides antioxidant protection for folate and vitamin E, keeping vitamin E in its most potent form. Vitamin C may afford protective effects against preeclampsia by participating in the scavenging of free radicals. Indeed, significantly lower levels of vitamin C have been observed in preeclamptic subjects than in controls. Woods et al., 185(1) AM. J. OBSTET. GYNECOL. 5-10 (2001); Kharb, 1 EURO. J. OBSTET. GYNECOL. REPROD. BIOL. 37-39 (2000); Milczarek et al., 210 MOL. CELL. BIOCHEM. 65-73 (2000).Vitamin C also enhances the absorption of iron. RDA, supra at 115. In addition, vitamin C is required for collagen synthesis, epinephrine synthesis, and bile acid formation. Moreover, vitamin C has been implicated in inhibiting atherosclerosis by being present in extracellular fluid of the arterial wall and potentiating nitric oxide activity, thus normalizing vascular function. In a specific embodiment, vitamin C may be included in the forms of ascorbic acid, ascorbates (calcium or sodium ascorbate), dehydroascorbic acid and salts, ascorbyl palmitate, ascorbyl phosphates and salts (such as sodium or magnesium ascorbyl phosphate), ascorbyl tetraisopalmitate, tetrahexyldecyl ascorbate, ascorbyl sulfates and salts, acylated ascorbic acid derivatives (such as 6-O-acyl-2-O-alpha-D-glucopyranosyl-L-ascorbic acids), 6-bromo-6-deoxy-L-ascorbic acid, and ascorbate salts. In a specific embodiment, vitamin C may be included in the form of ascorbic acid.

In another specific embodiment, vitamin C may be included in amounts ranging from about 15 mg to about 45 mg. In another specific embodiment, vitamin C may be included in amounts ranging from about 24 mg to about 36 mg. In another specific embodiment, vitamin C may be included in amounts ranging from about 27 mg to about 33 mg. In another embodiment, vitamin C may be included in an amount of about 30 mg.

In another specific embodiment, vitamin C may be included in specific ranges or amounts for each specific form. When provided in their specific forms, the provided numerical range or amount includes the amounts of the specific form and/or compounds that are equivalent to the specific form. For example, vitamin C may be in the form ascorbic acid and may be included in the amount of about 30 mg. Accordingly, in this example, “ascorbic acid in the amount of about 30 mg” would include 30 mg of ascorbic acid and/or its equivalents and would, for example, include a product having 30 mg ascorbyl palmitate instead of ascorbic acid.

In another specific embodiment, vitamin C in the form of ascorbic acid may be included in amounts ranging from about 15 mg to about 45 mg. In another specific embodiment, vitamin C in the form of ascorbic acid may be included in amounts ranging from about 24 mg to about 36 mg. In another specific embodiment, vitamin C in the form of ascorbic acid may be included in amounts ranging from about 27 mg to about 33 mg. In another embodiment, vitamin C in the form of ascorbic acid may be included in an amount of about 30 mg.

In a further embodiment, vitamin C may be present in the nutritional composition in any of one or a combination of forms disclosed herein in an amount of at least about 5 mg, at least about 10 mg, at least about 15 mg, at least about 20 mg, at least about 25 mg, at least about 30 mg, at least about 35 mg, at least about 40 mg, at least about 45 mg, at least about 50 mg, at least about 55 mg, at least about 60 mg, at least about 65 mg, at least about 70 mg, at least about 75 mg, at least about 80 mg, at least about 85 mg, at least about 90 mg, at least about 95 mg, at least about 100 mg, at least about 105 mg, at least about 110 mg, at least about 115 mg, at least about 120 mg, at least about 125 mg, at least about 130 mg, at least about 135 mg, at least about 140 mg, at least about 145 mg, at least about 150 mg, at least about 155 mg, at least about 160 mg, at least about 165 mg, at least about 170 mg, at least about 175 mg, at least about 180 mg, at least about 185 mg, at least about 190 mg, at least about 195 mg, and at least about 200 mg. Vitamin C may be present in the nutritional composition in a range of between and including any two of the foregoing values. In embodiments where vitamin C is present in a combination of forms, each constituent form may be present in a relative amount of about 10%, about 20%, about 30%, about 40%, about 50%, about 60%, about 70%, about 80%, about 90% of any one of the foregoing amounts for vitamin C.

The orally dissolvable compositions may comprise or use vitamin D. In another embodiment, the orally dissolvable compositions may include a beneficially increased supplementation of vitamin D. Vitamin D is a fat-soluble “hormone like” substance important for the maintenance of healthy bones. This vitamin increases the absorption of calcium and phosphorous from the gastrointestinal tract, and improves mineral resorption into bone tissue. The result of this physiological function is a correlation between adequate systemic levels in pregnancy and a long-lasting reduction in osteoporotic fractures throughout the lifespan of the newborn. MF Holick, “Vitamin D,” in MODERN NUTRITION IN HEALTH AND DISEASE , p. 313, M E Shils, J A Olsen and M. Shikeeds., Plea and Febiger, Philadelphia, Pa. (1994); M K Javaid et al., LANCET 367(9504):36-43 (2006).

Moreover, recent research suggests that vitamin D has more positive physiological effects than previous thought. Bischoff-Ferrari HA, 624 ADV EXP MED BIOL. 55-71 (2008); Holick MF, 357 N. ENG. J. MED. 266-81, (2007); Parikin et al., 89(3) J CLIN ENDOCRINOL METAB. 1196-99 (2004). For example, it has recently been determined that vitamin D also has a role in the enhancement of vascular function, defense against cancer, immuno-competence, blood pressure regulation and possessing the ability to enhance cellular insulin sensitivity in the human body. Due to the additional roles that vitamin D plays in the human body, it has recently been determined that higher daily vitamin D intake beyond current recommendations may be associated with better health outcomes. Bischoff-Ferrari HA, supra. Indeed, studies suggest increasing the serum level of 25-hydroxyvitamin D, a beneficial derivative of vitamin D, to a 30 ng/ml serum range. Id. A 30 ng/ml appears to be the most advantageous serum levels in recent studies reviewing subject bone mineral density (BMD), lower extremity function, dental health, risk of falls, admission to nursing home, fractures, cancer prevention and incident hypertension. Id.

Further, studies suggest that an intake of about 1000 IU of vitamin D₃ (cholecalciferol) per day for all adults may bring at least 50% of the population up to the 30 ng/ml serum range for 25-hydroxyvitamin D. Id. Current nutritional supplements, however, do not provide a high enough dosage for obtaining such a high serum level of 25-hydroxyvitamin D. Presently, the suggested daily amount of vitamin D, as stated by the U.S. Dietary Reference Intake for adequate intake (AI) of vitamin D for infants, children and men and women aged 19-50 is 200 IU/day. Adequate intake increases to 400 IU/day for men and women aged 51-70 and up to 600 IU/day past the age of 70. Id. Due to these studies, present nutritional supplements may be insufficient to remedy the current U.S. and global epidemic related to vitamin D deficiency.

Indeed, research findings indicate vitamin D status during pregnancy is more important than previous thought. Vitamin D′s role continues to expand in for example, infant immunity, neurodevelopment, birth weight, and incidence of asthma. Growing research findings regarding the importance of this hormone-like compound is due, in large part, to the fact that vitamin D receptors have now been identified on nearly every tissue and cell in the human body. H F DeLuca et al., FASEB J 15:2579-2585 (2001); D. Eyles et al., NEUROSCIENCE 118(3):641-653 (2003); C A Mannion et al., CMAJ 174(9):1273-1277 (2006); B W Hollis et al., CMAJ 174(9):1287-1290 (2006); American Academy of Allergy, Asthma and Immunology Annual Meeting, Miami, Fla. (March 2006). A nutritional supplement that includes a higher dosage amount of vitamin D, as compared to present nutritional supplements and, specifically, prenatal supplements, is therefore currently needed. Thus, one embodiment provides orally dissolvable compositions that provide a beneficial increased supplementation of vitamin D, specifically, for example prenatal, pregnant or breast feeding subjects.

The vitamin D of the orally dissolvable compositions may comprise vitamin D. In a specific embodiment, vitamin D may be in one or more the forms of vitamin D₃ (also known as calciol or cholecalciferol or colecalciferol), vitamin D₂ (also known as calciferol, ergocalciol, ergocalciferol, ercalciol , Deltalin or Viosterol), previtamin D₂, ergosterol, calcitriol (also known as 1,25-dihydroxycholecalciferol), 7-dehydrocholesterol, vitamin D₁, vitamin D₄ (also known as 22-dihydroergocalciferol, 22,23-dihydroercalciol or (24S)-methylcalciol), vitamin D₅ (also known as (24S)-Ethylcalciol or sitocalciferol), 7-dehydrositosterol, Lumisterol, 25-hydroxyvitamin D, all steroids that exhibit the biological activity of calciol, 25-fluorocalciol, (3S)-3-amino-3-deoxycalciol, 11α-acetoxycalciol, calcidiol (also known as 25-hydroxycholecalciferol or calcifediol), ercalcitriol, calcitetrol, tacalciol (also known as tachysterol₃), (5E)-isocalciol (also known as isovitamin D₃), Dihydroercalciol (also known as dihydrotachysterol3), (1S)-Hydroxycalciol (also known as 1α-hydroxycholecalciferol or alfacaleidol), (24R)-Hydroxycalcidiol (also known as 24(R),25-dihydroxycholecalciferol), Ercalcidiol, Ercalcitriol, Ertacalciol, (5E)-(10S)-10,19-Dihydroercalciol (also known as dihydrotachysterol2), (6Z)-Tacalciol (also known as precalciferol or pre-vitamin D), and (22E)-(24R)-Ethyl-22,23-didehydrocalciol also known as vitamin D₆.

In one embodiment, vitamin D may be present in the amount ranging from about 400 IU to about 1600 IU. In another embodiment, vitamin D may be present in the amount ranging from about 750 IU to about 1250 IU. In another embodiment, vitamin D is present in the amount ranging from about 900 IU to about 1100 IU. In another embodiment, vitamin D is present in the amount of about 1000 IU.

In another specific embodiment, vitamin D may be included in specific ranges or amounts for each specific form. When provided in their specific forms, the provided numerical range or amount includes the amounts of the specific form and/or compounds that are equivalent to the specific form. For example, vitamin D may be in the form vitamin D₃ and may be included in the amount of about 1000 IU. Accordingly, in this example, “vitamin D₃ in the amount of about 30 mg” would include 1000 IU of vitamin D₃ and/or its equivalents and would, for example, include a product having 1000 IU mg vitamin D₂ instead of vitamin D₃.

In another embodiment, the vitamin D of the orally dissolvable compositions may be vitamin D₃. In the body, vitamin D₃ is produced when its precursor is exposed to ultraviolet irradiation (e.g., sunlight) and then hydroxylated in the liver to form 25-hydroxyvitamin D₃, the major form of vitamin D in the circulation. This form of the vitamin may be hydroxylated again in the kidney, yielding 1,25 hydroxyvitamin D₃, the most potent form of vitamin D. As noted above, vitamin D₃ plays a role in the maintenance of calcium and phosphorus homeostasis, but it is also active in cell differentiation and immune function.

In one embodiment, vitamin D in the form of vitamin D₃ may be present in the amount ranging from about 400 IU to about 1600 IU. In another embodiment, vitamin D in the form of vitamin D₃ may be present in the amount ranging from about 750 IU to about 1250 IU. In another embodiment, vitamin D in the form of vitamin D₃ may be present in the amount ranging from about 900 IU to about 1100 IU. In another embodiment, vitamin D in the form of vitamin D₃ may be present in the amount of about 1000 IU.

In another embodiment, vitamin D may be present in an amount determined by a measure of mass, as opposed to International Units. One International Unit (IU) of vitamin D is defined as the biological equivalent of about 0.025 μg of vitamin D₃. See REMINGTON, THE SCIENCE AND PRACTICE OF PHARMACY (22^{th} ed. 2012). Accordingly, 400 IU to about 1600 IU is the biological equivalent of about 10 μg to about 40 μg. In another example, about 750 IU to about 1250 IU is the biological equivalent of about 18.75 μg to about 31.25 μg. In another example, about 900 IU to about 1100 IU is the biological equivalent of about 22.5 μg to about 27.5 μg. In another example, 1000 IU is the biological equivalent of about 25 μg.

In a further embodiment, vitamin D may be present in the nutritional composition in any of one or a combination of forms disclosed herein in an amount of at least about 400 IU, at least about 450 IU, at least about 500 IU, at least about 550 IU, at least about 600 IU, at least about 650 IU, at least about 700 IU, at least about 750 IU, at least about 800 IU, at least about 850 IU, at least about 900 IU, at least about 950 IU, at least about 1000 IU, at least about 1050 IU, at least about 1100 IU, at least about 1150 IU, at least about 1200 IU, at least about 1250 IU, at least about 1300 IU, at least about 1350 IU, at least about 1400 IU, at least about 1450 IU, at least about 1500 IU, at least about 1550 IU, at least about 1600 IU, at least about 1650 IU, at least about 1700 IU, at least about 1750 IU, at least about 1800 IU, at least about 1850 IU, at least about 1900 IU, and at least about 1950 IU. Vitamin D may be present in the nutritional composition in a range of between and including any two of the foregoing values. In embodiments where vitamin D is present in a combination of forms, each constituent form may be present in a relative amount of about 10%, about 20%, about 30%, about 40%, about 50%, about 60%, about 70%, about 80%, about 90% of any one of the foregoing amounts for vitamin D.

The orally dissolvable compositions may comprise or use vitamin E. Vitamin E is a fat-soluble vitamin antioxidant found in biological membranes where it protects the phospholipid membrane from oxidative stress. Vitamin E inhibits the oxidation of unsaturated fatty acids by trapping peroxyl free radicals. It is also an antiatherogenic agent, and studies have demonstrated a reduced risk of coronary heart disease with increased intake of vitamin E. Stampfer et al., 328 NEW ENG. J. MED. 1444-49 (1993). In addition, vitamin E, like beta carotene and vitamin C, may afford protective effects against preeclampsia by participating in the scavenging of free radicals. As with vitamin C, significantly lower levels of vitamin E have been observed in preeclamptic subjects than in controls. Woods et al., AM J OBSTET GYNECOL, 185(1):5-10 (2001); Kharb, EURO. J. OBSTET GYNECOL REPROD BIOL, 1:37-39 (2000); Milczarek et al., MOL CELL BIOCHEM, 210:65-73 (2000). In a specific embodiment, vitamin E may be included in one or more of the forms of alpha, beta, gamma, and delta tocopherols in its natural or synthetic (dl) forms; alpha, beta, gamma, and delta tocotrienols in its natural or synthetic (dl) forms, dl-alpha tocopheryl derivatives such as dl-alpha tocopheryl esters, dl-alpha-tocopheryl acetate or succinate and d-alpha-tocopheryl acetate or dl-alpha tocopheryl phosphates (such as Ester-E®). In a specific embodiment, vitamin E may be included in the form of d-alpha-tocopheryl acetate. In another specific embodiment, vitamin E may be included in the form of an equivalent molar amount of d-alpha tocopheryl succinate.

In another specific embodiment, vitamin E may be included in amounts ranging from about 10 IU to about 30 IU. In another specific embodiment, vitamin E may be included in amounts ranging from about 15 IU to about 25 IU. In another specific embodiment, vitamin E may be included in amounts ranging from about 18 IU to about 22 IU. In another embodiment, vitamin E may be included in an amount of about 20 IU.

In another specific embodiment, vitamin E may be included in specific ranges or amounts for each specific form. When provided in their specific forms, the provided numerical range or amount includes the amounts of the specific form and/or compounds that are equivalent to the specific form. For example, vitamin E may be in the form d-alpha-tocopheryl acetate and may be included in the amount of about 20 IU. Accordingly, in this example, “d-alpha-tocopheryl in the amount of about 20 IU” would include 20 IU of d-alpha-tocopheryl and/or its equivalents and would, for example, include a product having 20 IU alpha-tocotrienol instead of d-alpha-tocopheryl.

In a further embodiment, vitamin E may be present in the nutritional composition in any of one or a combination of forms disclosed herein in an amount of at least about 5 IU, at least about 6 IU, at least about 7 IU, at least about 8 IU, at least about 9 IU, at least about 10 IU, at least about 11 IU, at least about 12 IU, at least about 13 IU, at least about 14 IU, at least about 15 IU, at least about 16 IU, at least about 17 IU, at least about 18 IU, at least about 19 IU, at least about 20 IU, at least about 21 IU, at least about 22 IU, at least about 23 IU, at least about 24 IU, at least about 25 IU, at least about 26 IU, at least about 27 IU, at least about 28 IU, at least about 29 IU, at least about 30 IU, at least about 31 IU, at least about 32 IU, at least about 33 IU, at least about 34 IU, at least about 35 IU, at least about 36 IU, at least about 37 IU, at least about 38 IU, at least about 39 IU, and at least about 40 IU. Vitamin E may be present in the nutritional composition in a range of between and including any two of the foregoing values. In embodiments where vitamin E is present in a combination of forms, each constituent form may be present in a relative amount of about 10%, about 20%, about 30%, about 40%, about 50%, about 60%, about 70%, about 80%, about 90% of any one of the foregoing amounts for vitamin E.

The orally dissolvable compositions may comprise or use iron. A primary function of iron is to carry oxygen to bodily tissues via the hemoglobin part of red blood cells. Supplemental intake of iron is critical to preventing anemia, a disorder associated with a variety of physiological states including, for example, pregnancy. Bothwell, 72(Supp.) AM. J. CLIN. NUTR. 257S-64S (2000). Severe anemia may have adverse effects upon a pregnant woman and a developing child. Specifically, significant depression of hemoglobin has been associated with poor pregnancy outcome. Black, supra; Sifakis & Pharmakides, 900 ANN. N.Y. ACAD. SCI. 125-36 (2000). The, orally dissolvable compositions may include iron in one or more of the forms of elemental iron, in the form of a salt, chelated form, non-chelated form, chelated to an amino acid, carbonyl iron, ferrous gluconate, ferrous fumarate, polysaccharide iron complex, elemental polysaccharide iron, polysaccharide iron, ferrous (II)-bis-glycinate chelate, ferrous asparto glycinate, ferrous bisglycinate, ferrous bisglycinate hydrochloride, ferrous bisglycinate, elemental ferrous bisglycinate, ferrous sulfate, ferronyl (micronized), as Iron Aid, iron protein succinylate, carbonyl iron, Sumalate iron, Heme iron complex, as Ferrochel amino acid chelate, heme iron polypeptide as Proferrin-bovine source, as heme iron polypeptide (bovine source) as sodium iron EDTA (Ferrazone), ferric ammonium citrate, elemental iron, and ferric pyrophosphate.

In a specific embodiment, iron may be included in the form of polysaccharide iron complex. In another specific embodiment, iron may be included in the form of an equivalent molar amount of ferrous fumarate. In another specific embodiment, iron may be included in amounts ranging from about 14.5 mg to about 43.5 mg. In another specific embodiment, iron may be included in amounts ranging from about 21.6 mg to about 32.4 mg. In another specific embodiment, iron may be included in amounts ranging from about 26 mg to about 32 mg. In another embodiment, iron may be included in an amount of about 29 mg.

In another specific embodiment, iron may be included in specific ranges or amounts for each specific form. When provided in their specific forms, the provided numerical range or amount includes the amounts of the specific form and/or compounds that are equivalent to the specific form. For example, iron may be in the form polysaccharide iron complex and may be included in the amount of about 29 mg. Accordingly, in this example, “polysaccharide iron complex in the amount of about 29 mg” would include 29 mg of polysaccharide iron complex and/or its equivalents and would, for example, include a product having 29 mg ferrous fumarate instead of polysaccharide iron complex.

In a further embodiment, iron may be present in the nutritional composition in any one or a combination of forms disclosed herein an amount of at least about 10 mg, at least about 15 mg, at least about 20 mg, at least about 25 mg, at least about 30 mg, at least about 35 mg, at least about 40 mg, at least about 45 mg, at least about 50 mg, at least about 55 mg, at least about 60 mg, at least about 65 mg, at least about 70 mg, at least about 75 mg, at least about 80 mg, at least about 85 mg, at least about 90 mg, at least about 95 mg, at least about 100 mg, at least about 105 mg, at least about 110 mg, at least about 115 mg, at least about 120 mg, and at least about 125 mg. Iron may be present in the nutritional composition in a range of between and including any two of the foregoing values. In embodiments where iron present in a combination of forms, each constituent form may be present in a relative amount of about 10%, about 20%, about 30%, about 40%, about 50%, about 60%, about 70%, about 80%, about 90% of any one of the foregoing amounts for iron.

The orally dissolvable compositions may comprise or use iodine. Iodine provides nutritional benefits as it is an essential component of the thyroid hormones that are involved in the regulation of various enzymes and metabolic processes, such as thyroxine and triiodothyronine. Thyroid hormones play pivotal roles in metabolism. Consequences of deficiency (hypothyroidism) and excess (hyperthyroidism) are well-recognized clinically. Simpson et al., THE JOURNAL OF MATERNAL-FETAL AND NEONATAL MEDICINE, Micronutrients and women of reproductive potential: required dietary intake and consequences of dietary deficiency or excess. Part II—Vitamin D, Vitamin A, Iron, Zinc, Iodine, Essential Fatty Acids, 1-2, epub online 2010. Indeed, iodine deficiency disorders (IDD) include mental retardation, hypothyroidism, goiter, cretinism, and varying degrees of other growth and developmental abnormalities, which can be a result from inadequate thyroid hormone production from lack of sufficient iodine. Further, iodine is an important element in breast milk for infant nutrition. An adequate concentration of iodine in breast milk is essential to provide for optimal neonatal thyroid hormone stores and to prevent impaired neurological development in breast-fed newborns. In many countries of the world, low iodine content of the breast milk indicates less than optimum maternal and infant iodine nutrition. F. Azizi et al., CLIN ENDOCRINOL;70(5):803-9 (2009). Iodine deficiency is a major public health problem in nearly all countries, particularly for subjects during pregnancy and lactation. The National Health and Nutrition Examination survey data also found 14.9% of women aged 15-44 years and 6.9% of pregnant women to have urinary iodine concentrations of only 50 mg/L, indicating iodine intake of less than 100 mg daily. Simpson, supra. The American Thyroid Association thus also recommends that women receive 150 mg iodine supplements daily during pregnancy and during lactation, which is often the upper limit for iodine dosing amounts in prenatal supplements. Id. Regardless of such recommendations, iodine nutrition and supplementation is lacking. For example, in Europe, most women are iodine deficient during pregnancy, with less than 50% receiving iodine supplementation; of 40 countries, only nine met the requirements of iodized salt at the household level to be at least 90% of the DRI. Id. Iodine nutrition of women of childbearing age thus remains inadequate and an area worthy of public health concern. Id. A nutritional supplement that includes a higher dosage amount of iodine, as compared to present nutritional supplements and, specifically, prenatal supplements, is therefore currently needed. Thus, in one embodiment, the orally dissolvable compositions provide a beneficial increased supplementation of iodine, specifically, for example prenatal, pregnant or breast feeding subjects.

In a specific embodiment, iodine may be in the forms of elemental iodine, iodized salt, Lugol's iodine, sodium iodide, potassium iodide, potassium iodate, nascent iodine, and Nano-Colloidal Detoxified Iodine. In another specific embodiment, iodine may be present in the amounts ranging from about 75 μg to about 225 μg. In another embodiment, iodine may be present in the amounts ranging from about 120 μg to about 180 μg. In another embodiment, iodine may be present in the amounts ranging from about 135 μg to about 165 μg. In another embodiment, iodine may be present in the amount of about 150 μg.

In another specific embodiment, iodine may be included in specific ranges or amounts for each specific form. When provided in their specific forms, the provided numerical range or amount includes the amounts of the specific form and/or compounds that are equivalent to the specific form. For example, iodine may be in the form potassium iodide and may be included in the amount of about 150 μg. Accordingly, in this example, “potassium iodide in the amount of about 150 μg ” would include 150 μg of potassium iodide and/or its equivalents and would, for example, include a product having 150 μg Nano-Colloidal Detoxified Iodine instead of potassium iodide.

In a further embodiment, iodine may be present in the nutritional composition in any one or a combination of forms disclosed herein an amount of at least about 1 mg, at least about 75 μg, at least about 80 μg, at least about 85 μg, at least about 90 μg, at least about 95 μg, at least about 100 μg, at least about 105 μg, at least about 110 μg, at least about 115 μg, at least about 120 μg, at least about 125 μg, at least about 130 μg, at least about 135 μg, at least about 140 μg, at least about 145 μg, at least about 150 μg, at least about 155 μg, at least about 160 μg, at least about 165 μg, at least about 170 μg, at least about 175 μg, at least about 180 μg, at least about 185 μg, at least about 190 μg, at least about 195 μg, at least about 200 μg, at least about 205 μg, at least about 210 μg, at least about 215 μg, at least about 220 μg, at least about 225 μg, at least about 230 μg, at least about 235 μg, at least about 240 μg, at least about 245 μg, and at least about 250 μg. Iodine may be present in the nutritional composition in a range of between and including any two of the foregoing values. In embodiments where iodine is present in a combination of forms, each constituent form may be present in a relative amount of about 10%, about 20%, about 30%, about 40%, about 50%, about 60%, about 70%, about 80%, about 90% of any one of the foregoing amounts for iodine.

The orally dissolvable compositions may comprise or use magnesium. Magnesium is found primarily in both bone and muscle and is important for over 300 different enzyme reactions. A primary function of magnesium is to bind to phosphate groups in adenosine triphosphate (ATP), thereby forming a complex that assists in the transfer of ATP phosphate. Magnesium also functions within cells as a membrane stabilizer. Magnesium plays roles in nucleic acid synthesis, glycolysis, transcription of DNA and RNA, amino acid activation, membrane transport, transketolase reactions, and protein synthesis. James L.L. Groff et al., ADVANCED NUTRITION AND HUMAN METABOLISM 341 (2d ed. 1996). It is also involved in the formation of cAMP, a cytosolic second messenger that plays a role in cell signaling mechanisms. Magnesium also functions both synergistically and antagonistically with calcium in neuromuscular transmission. RDA, supra at 188. Specifically, magnesium is critical for the maintenance of electrochemical potentials of nerve and muscle membranes and the neuromuscular junction transmissions, particularly important in the heart. Not surprisingly, magnesium deficiency is tied to cardiovascular disease and hypertension. Agus et al., 17 CRIT. CARE CLIN. 175-87 (2001). Indeed, oral magnesium therapy improves endothelial function in subjects with coronary disease. Shechter et al., 102 CIRCULATION 2353-58 (2000).

Magnesium is available in a variety of salts and can be included in the orally dissolvable compositions in either chelated or nonchelated form. In one specific embodiment, magnesium may be included in the forms of elemental magnesium, in the form of a salt, in a chelated form, in a non-chelated form, magnesium acetate, magnesium carbonate, magnesium gluconate, magnesium chloride, magnesium citrate, magnesium silicate, magnesium stearate, magnesium sulfate, magnesium oxide, and magnesium chelated to an amino acid (magnesium glycinate, magnesium aspartate).

In another specific embodiment, magnesium may be present in the amounts ranging from about 10 mg to about 30 mg. In another embodiment, magnesium may be present in the amounts ranging from about 16 mg to about 24 mg. In another embodiment, magnesium may be present in the amounts ranging from about 18 mg to about 22 mg. In another embodiment, magnesium may be present in the amount of about 20 mg.

In another specific embodiment, magnesium may be included in specific ranges or amounts for each specific form. When provided in their specific forms, the provided numerical range or amount includes the amounts of the specific form and/or compounds that are equivalent to the specific form. For example, magnesium may be in the form magnesium oxide and may be included in the amount of about 20 mg. Accordingly, in this example, “magnesium oxide in the amount of about 20 mg” would include 20 mg of magnesium oxide and/or its equivalents and would, for example, include a product having 20 mg magnesium stearate instead of magnesium oxide.

In a further embodiment, magnesium may be present in the nutritional composition in any of one or a combination of forms disclosed herein in an amount of at least about 5 mg, at least about 10 mg, at least about 15 mg, at least about 20 mg, at least about 25 mg, at least about 30 mg, at least about 35 mg, at least about 40 mg, at least about 45 mg, at least about 50 mg, at least about 55 mg, at least about 60 mg, at least about 65 mg, at least about 70 mg, at least about 75 mg, at least about 80 mg, at least about 85 mg, at least about 90 mg, at least about 95 mg, and at least about 100 mg. Magnesium may be present in the nutritional composition in a range of between and including any two of the foregoing values. In embodiments where magnesium is present in a combination of forms, each constituent form may be present in a relative amount of about 10%, about 20%, about 30%, about 40%, about 50%, about 60%, about 70%, about 80%, about 90% of any one of the foregoing amounts for magnesium.

The orally dissolvable compositions may comprise or use zinc. Zinc plays a role in numerous metabolic activities such as nucleic acid production, protein synthesis, and development of the immune system. There are more than 200 zinc metalloenzymes including aldolase, alcohol dehydrogenase, RNA polymerase, and protein kinase C. Zima et al., 17 BLOOD PURIF. 182-86 (1999). Zinc stabilizes RNA and DNA structures, forms zinc fingers in nuclear receptors, and is a component of chromatin proteins involved in transcription and replication. Deficiencies of zinc during pregnancy have been shown to contribute to severe fetal abnormalities. Srinivas et al., 68(6) INDIAN J. PEDIATR. 519-22 (2001); Yang et al., 13(4) BIOMED. ENVIRON. SCI. 280-86 (2000); King, 71(Supp.) AM. J. CLIN. NUTR. 1334S-43S (2000). Indeed, the recommended daily allowance for zinc increases during pregnancy. A higher dose of zinc, however, is associated with causing nausea in some subjects. Thus, for pregnant women or other subjects that are more susceptible to nausea, a conservative amount of zinc that still provides adequate nutritional supplementation is desirable. Zinc is available in many forms and may be included in the orally dissolvable compositions in chelated or nonchelated form.

In a specific embodiment, zinc may be provided in one or more of the forms of elemental zinc, in the form of a salt, in a chelated form, in a non-chelated form, zinc acetate, zinc gluconate, zinc picolinate, zinc sulfate and zinc oxide. In a specific embodiment, zinc may be included in the form of zinc oxide. In another specific embodiment, zinc may be included in amounts ranging from about 12.5 mg to about 37.5 mg. In another specific embodiment, zinc may be included in amounts ranging from about 20 mg to about 30 mg. In another specific embodiment, zinc may be included in amounts ranging from about 22.5 mg to about 27.5 mg. In another embodiment, zinc may be included in an amount of about 25 mg.

In another specific embodiment, zinc may be included in specific ranges or amounts for each specific form. When provided in their specific forms, the provided numerical range or amount includes the amounts of the specific form and/or compounds that are equivalent to the specific form. For example, zinc may be in the form zinc oxide and may be included in the amount of about 25 mg. Accordingly, in this example, “zinc oxide in the amount of about 25 mg” would include 25 mg of zinc oxide and/or its equivalents and would, for example, include a product having 25 mg zinc sulfate instead of zinc oxide.

In a further embodiment, zinc may be present in the nutritional composition in any of one or a combination of forms disclosed herein in an amount of at least about 5 mg, at least about 10 mg, at least about 15 mg, at least about 20 mg, at least about 25 mg, at least about 30 mg, at least about 35 mg, at least about 40 mg, at least about 45 mg, at least about 50 mg, at least about 55 mg, at least about 60 mg, at least about 65 mg, at least about 70 mg, at least about 75 mg, at least about 80 mg, at least about 85 mg, at least about 90 mg, at least about 95 mg, and at least about 100 mg. Zinc may be present in the nutritional composition in a range of between and including any two of the foregoing values. In embodiments where zinc is present in a combination of forms, each constituent form may be present in a relative amount of about 10%, about 20%, about 30%, about 40%, about 50%, about 60%, about 70%, about 80%, about 90% of any one of the foregoing amounts for zinc.

The orally dissolvable compositions may comprise or use copper. Copper is an important component of the process of gene expression. Additionally, one of copper's most vital roles is to help form hemoglobin, which, as previously discussed, carries oxygen to tissues via its iron component. In this respect copper plays a key role in protecting against anemia. Further, deficiencies of copper may lead to neutropenia and bone abnormalities in pregnant and lactating subjects. Uauy et al., AMER J CLIN NUTR 67:952S-959S (Supp.) (1998). In addition, a developing child must accumulate copper at a rate of 50 mcgxkg−1×d−1 over the latter half of pregnancy; any deficiency in accumulation may lead to low birth weight and protein-energy malnutrition. Id. Many forms of copper are known to those skilled in the art, including copper oxide (Reade Advanced Materials, Providence, R.I.). In a specific embodiment, copper may be included in the forms of a salt, in a chelated form, in a non-chelated form, cupric oxide, copper sulfate, copper gluconate, copper citrate, cupric acetate, alkaline copper carbonate, and copper salicylate.

In another specific embodiment, copper may be included in amounts ranging from about 1.0 mg to about 3.0 mg. In another specific embodiment, copper may be included in amounts ranging from about 1.6 mg to about 2.4 mg. In another specific embodiment, copper may be included in amounts ranging from about 1.8 mg to about 2.2 mg. In another embodiment, copper may be included in an amount of about 2.0 mg.

In another specific embodiment, copper may be included in specific ranges or amounts for each specific form. When provided in their specific forms, the provided numerical range or amount includes the amounts of the specific form and/or compounds that are equivalent to the specific form. For example, copper may be in the form copper oxide and may be included in the amount of about 2.0 mg. Accordingly, in this example, “copper oxide in the amount of about 2.0 mg” would include 2.0 mg of copper oxide and/or its equivalents and would, for example, include a product having 2.0 mg copper sulfate instead of copper oxide.

In a further embodiment, copper may be present in the nutritional composition in any of one or a combination of forms disclosed herein in an amount of at least about 0.5 mg, at least about 0.6 mg, at least about 0.7 mg, at least about 0.8 mg, at least about 0.9 mg, at least about 1 mg, at least about 1.1 mg, at least about 1.2 mg, at least about 1.3 mg, at least about 1.4 mg, at least about 1.5 mg, at least about 1.6 mg, at least about 1.7 mg, at least about 1.8 mg, at least about 1.9 mg, at least about 2 mg, at least about 2.1 mg, at least about 2.2 mg, at least about 2.3 mg, at least about 2.4 mg, at least about 2.5 mg, at least about 2.6 mg, at least about 2.7 mg, at least about 2.8 mg, at least about 2.9 mg, at least about 3.0, at least about 3.1 mg, at least about 3.2 mg, at least about 3.3 mg, at least about 3.4 mg, and at least about 3.5 mg. Copper may be present in the nutritional composition in a range of between and including any two of the foregoing values. In embodiments where copper is present in a combination of forms, each constituent form may be present in a relative amount of about 10%, about 20%, about 30%, about 40%, about 50%, about 60%, about 70%, about 80%, about 90% of any one of the foregoing amounts for copper.

The orally dissolvable compositions may comprise or use omega-3 fatty acids. Omega-3 fatty acids play integral roles in physiological mechanisms that serve to prevent, treat and/or alleviate the occurrence or negative effects of some diseases and has shown multiple health-promoting properties in adults. For example, omega-3 fatty acids are linked to health benefits such as preventing the occurrence of cancer, preventing the occurrence of heart disease, and are helpful in brain health and immune function. Indeed, omega-3 fatty acids include essential fatty acids linked to numerous health benefits, such as docahexaenoic acid (or docosahexaenoic acid, DHA), eicosapentaenoic acid (EPA) and a-linolenic acid (ALA). In another specific embodiment, the orally dissolvable compositions may comprise or use DHA. In another specific embodiment, the orally dissolvable compositions may comprise or use EPA. In another specific embodiment, the orally dissolvable compositions may comprise or use ALA.

The omega-3 fatty acid DHA, a major component of fish oil, has been shown to be of particular importance, especially during pregnancy or for lowering blood pressure. Indeed, studies suggest that DHA, but not EPA, reduce ambulatory blood pressure and heart rate in hyperlipidemic men. TA Mori et al., HYPERTENSION. 34:253-260 (1999). The results of this study thus suggest that DHA is the principal fatty acid in fish and fish oils that is responsible for blood pressure and heart rate effects in humans. Id.

Further, DHA is vital for optimal fetal and infant brain/cognitive development, as well as for normal brain function throughout life. FM Rioux, O. Hernell et al., ACTA PAEDIATR 95(2):137-144 (2006). The sleep patterns of infants born to pregnant women with higher plasma phospholipid DHA suggest greater central nerve system maturity. SR Cheruku, CJ Lammi-Keefe et al., Am J CLIN NUTR 76:608-613, 2002. Additionally, children with Attention Deficit Hyperactivity Disorder (ADHD) have been shown to have abnormal levels of DHA. EA Mitchell, M. Manku et al., CLIN PEDIATR 26:406-411 (1986); LJ Stevens, JR Burgess et al., PHYSIOL BEHAV 59:915-920 (1996). Studies have indicated a correlation between maternal DHA intake and intelligence quotient in the child. The direct correlation between brain development and systemic DHA status is secondary to the fact that DHA is taken up by the brain in preference to other fatty acids. Adequate DHA levels in pregnancy have also been correlated with optimizing the length of gestation and decreasing the risk of neurodevelopmental psychopathology. These critical findings have prompted the National Institute of Health (NIH) to recommend that pregnant women consume at least 300 mg of omega-3 fatty acids during pregnancy. N. Neurenger et al., NUTR REV 44:285-294 (1986); G. Hornstra et al., AM J CLIN NUTR 71:285S-291S (2000); IB Helland et al., PEDIATRICS 111:E39-E44 (2003); F. Facchinetti et al., EUR REV MED PHARMACOL SCI 9(1):41-48 (2005); RK McNamara et al., PROSTAGLANDINS LEUKOT ESSENT FATTY ACIDS (29 August 2006).

DHA is also important for the development of the infant retina and improving the visual acuity of the infant. C A Francois, W E Connor et al., AM J CLIN NUTR 77:226-233 (2003). Preterm infants have a more rapid development of visual acuity if fed human milk or formula enriched with DHA, compared to standard formula. M H Jorgensen, K F Michaelsen et al., LIPIDS 31(1):99-105 (1996). An increase in visual acuity has also been observed to develop more rapidly in term infants breast-fed from subjects whose diets are supplemented with DHA. Id.

In addition to the aforementioned benefit of DHA to the developing child, this essential fatty acid has also shown multiple health-promoting properties in adults. These include anti-thrombotic, anti-inflammatory and anti-atherosclerotic activity, all of which reduce the risk of heart disease. M Laidlaw and B J Holub, AM J CLIN NUTR 77:37-42 (2003). Inverse relationships have also been found between systemic levels of omega-3 fatty acids such as DHA and incidence and severity of mood disorders and depression, including postpartum depression. Therefore, introduction of omega-3 during pregnancy has a double benefit, to both developing child and pregnant woman. FB Hu et al., JAMA 287(14):1815-1821 (2002); C. Von Schacky et al., ANN INTERN MED 130:554-562 (1999); G. Parker et al., AM J PSYCHIATRY 163(6):969-978 (2006); S J Otto et al., PROSTAGLANDINS LEUKOT ESSENT FATTY ACIDS 69(3):237-243 (2003).

For women, DHA is particularly useful in counteracting the progression of breast cancer. Human breast cancer cells exposed to DHA exhibit an increase in cell death by apoptosis. B A Stoll, BR J NUTR 87(3):193-198, 2002. DHA also inhibits cyclooxygenase-2, which promotes mammary carcinogenesis. Id. DHA supplementation during pregnancy has also been shown to increase the length of gestation by about six days, helping pregnant women carry to a healthy full term. C M Smuts et al., OBSTETRICS AND GYNECOLOGY 101(3):469-479 (2003).

Intake of omega-3 fatty acids such as DHA not only leads to their incorporation into cell membrane lipids (B A Stoll, BR JNUTR 87(3):193-198 (2002)), but also storage in adipose tissue and secretion in breast milk. C A Francois, W E Connor et al., AM J CLIN NUTR 77:226-233 (2003). Although the human body can derive a limited amount of DHA from ALA, another fatty acid, this process is inefficient for optimal needs. A rich dietary source of direct DHA is fish. Id. However, some lactating subjects are vegetarians, have limited access to fish or simply do not like fish. A further problem with encouraging increased fish intake in pregnancy is that most species contain methyl mercury (MeHg) in various amounts. MeHg is a potent neurotoxin that can increase the risk of retarded cognitive development. This concern prompted both the United States Environmental Protection Agency (2004) and the Food and Drug Administration (2001) to issue advisories recommending that pregnant women modify their fish consumption. These recommendations have resulted in a reduced intake of fish during pregnancy, thus helping to protect against fetal MeHg related harm. However, this has concurrently reduced maternal intake of DHA. In fact, a recent dietary study of over 100 pregnant or nursing subjects in the United States showed an astonishingly low intake of DHA on average (60-80 mg/day), and a dangerously low percentage (<2) consumed the aforementioned recommended intake of 300 mg/day of DHA as set forth by the NIH. JT Cohen et al., AM J PREV MED, 29:353-365 (2005); U.S. Department of Health and Human Services, U.S. Environmental Protection Agency, “What you need to know about mercury in fish and shellfish,” Report EPA-823-F-04-009 (March 2004); E. Oken et al., OBSTET GYNECOL 102:346-351 (2003).

DHA may be obtained in solid form, such as in a whole-cell microbial product, or in liquid form, such as in an oil. An example of DHA in oil form is DHASCO®-T vegetable oil from micro-algae (Martek Biosciences Corporation, Columbia, MD). In a specific composition, the DHA is DHAgold®, life's DHATM (DHASCO®), any Algae Oil, Krill Oil and/or vegetarian DHA.

In a specific embodiment, the source of DHA may be from one or more of animal, fish, plants, algae or microorganism production.

In another embodiment, the orally dissolvable compositions may include DHA derived from algae. DHA derived from algae, as opposed to being derived from fish oil, has numerous beneficial effects. First, the DHA from algae does not have the “fishy” smell that can come with DHA from fish oil. Indeed, high doses of DHA from fish oil may result in the subject having an unappealing after taste or a slight “fishy” body odor or “fishy” odor on the subject's breath. Second, DHA derived from algae can be more easily regulated to assure consistency and further remove the risk of added chemicals or other dangers. For example, DHA from algae would not have the risk of being tainted with mercury as opposed to DHA from fish oil. Thus, DHA from algae provides pregnant women and a developing child with DHA without this risk and dangers of mercury. In a specific embodiment, the source of DHA may be from algae oil. In another specific embodiment, the source of algae oil may be one or more of microalgae Schizochytrium sp., microalgae Crypthecodinium cohnii, microalgae Ulkenia sp. SAM2179, microalgae Schizochytrium linacinum strain SC-1. In another specific embodiment the source of DHA may be Martek Oil C53-0100, Martek Oil S35-O300, and/or any similar or equivalent product.

In a specific embodiment of the invention, the orally dissolvable compositions may include DHA derived from eggs. An example is OmEGGa DHA® (Vertical Pharmaceuticals, LLC, Sayreville, N.J.).

In another specific embodiment, omega-3 fatty acids may be included in amounts ranging from about 100 mg to about 300 mg. In another specific embodiment, omega-3 fatty acids may be included in amounts ranging from about 160 mg to about 240 mg. In another specific embodiment, omega-3 fatty acids may be included in amounts ranging from about 180 mg to about 220 mg. In another embodiment, omega-3 fatty acids may be included in an amount of about 200 mg.

In another specific embodiment, omega-3 fatty acids may be included in specific ranges or amounts for each specific form. When provided in their specific forms, the provided numerical range or amount includes the amounts of the specific form and/or compounds that are equivalent to the specific form. For example, omega-3 fatty acids may be in the form of DHA and may be included in the amount of about 200 mg. Accordingly, in this example, “DHA in the amount of about 200 mg” would include 200 mg of DHA and/or its equivalents and would, for example, include a product having 200 mg EPA instead of DHA.

In another specific embodiment, omega-3 fatty acids may be in the form of DHA and may be included in amounts ranging from about 100 mg to about 300 mg. In another specific embodiment, omega-3 fatty acids in the form of DHA may be included in amounts ranging from about 160 mg to about 240 mg. In another specific embodiment, omega-3 fatty acids in the form of DHA may be included in amounts ranging from about 180 mg to about 220 mg. In another embodiment, omega-3 fatty acids in the form of DHA may be included in an amount of about 200 mg.

In another specific embodiment, the source of omega-3 fatty acids may be algal oil. The algal oil may be one or more of algae oil may be one or more of microalgae Schizochytrium sp, microalgae Crypthecodinium cohnii, microalgae Ulkenia sp. SAM2179, microalgae Schizochytrium linacinum strain SC-1. In another specific embodiment the source of DHA may be Martek Oil C53-0100. The algal oil may be present in the nutritional composition in any one or a combination of forms disclosed herein in an amount of at least about 200 mg, at least about 210 mg, at least about 215 mg, at least about 220 mg, at least about 225 mg, at least about 230 mg, at least about 235 mg, at least about 240 mg, at least about 245 mg, at least about 250 mg, at least about 255 mg, at least about 260 mg, at least about 265 mg, at least about 270 mg, at least about 275 mg, at least about 280 mg, at least about 285 mg, at least about 290 mg, at least about 295 mg, at least about 230 mg, at least about 300 mg, at least about 305 mg, at least about 310 mg, at least about 315 mg, at least about 320 mg, at least about 325 mg, at least about 330 mg, at least about 335 mg, at least about 340 mg, at least about 345 mg, at least about 350 mg, at least about 355 mg, at least about 360 mg, at least about 365 mg, at least about 370 mg, at least about 375 mg, at least about 380 mg, at least about 385 mg, at least about 390 mg, at least about 395 mg, at least about 400 mg, at least about 405 mg, at least about 410 mg, at least about 415 mg, at least about 420 mg, at least about 425, at least about 430 mg, at least about 435 mg, at least about 440 mg, at least about 445 mg, and at least about 450 mg. The source of omega-3 fatty acids may be present in the nutritional composition in a range of between and including any two of the foregoing values. In embodiments where the source of omega-3 fatty acids is present in a combination of forms, each constituent form may be present in a relative amount of about 10%, about 20%, about 30%, about 40%, about 50%, about 60%, about 70%, about 80%, about 90% of any one of the foregoing amounts.

It is understood that for the amounts provided for the source of omega-3 fatty acids, the content of the omega-3 fatty acid, such as DHA, may be in an amount less than the total. For example, the source of omega-3 fatty acid may be present in an amount of 415 mg and may comprise DHA in an amount of about 200 mg.

Those skilled in the art will further appreciate that because the ingredients of the orally dissolvable compositions are in a substantially homogeneous admixture with one another, the compatibility, stability and bioavailability of the ingredients may be affected by one another. Accordingly, in one embodiment, one or more of the ingredients may be provided in encapsulated form. In one embodiment, one or both of iron and folic acid may be provided in encapsulated forms.

In an embodiment of the invention, folic acid may be encapsulated prior to incorporation into the orally dissolvable compositions. Folic acid may be sensitive to temperature, oxygen, light, and processing conditions. Thus in one embodiment, the folic acid may be incorporated in microcapsules using alginate and combinations of alginate and pectin polymers to improve stability in admixture with the ingredients of the orally dissolvable compositions. The blended alginate and pectin polymer matrix mixtures are believed to provide an increased folic acid encapsulation efficiency and reduced leakage from the capsules as compared to those made with alginate alone. Madziva H, et al. “Alginate-pectin microcapsules as a potential for folic acid delivery in foods.” J. Microencapsul., 2005 June; 22(4):343-51. In one embodiment, the folic acid is microencapsulated with cellulose and, in particular, with ethyl cellulose to reduce degradation due to processing or manufacturing conditions. The encapsulated folic acid, therefore, comprises folic acid (folacin), ethyl cellulose and dibutyl sebecate. The folic acid may have a particle size of no less than 98% through a 40 mesh sieve and a bulk density of no more than about 0.25 glee. Each gram of the encapsulated folic acid delivers about 0.750 mg of folic acid. In one embodiment, the folic acid may be encapsulated in cellulose, such as a modified cellulose or an ethyl cellulose.

Similarly, iron may also be encapsulated prior to incorporation into the orally dissolvable compositions in order to deliver meaningful levels of bioavailable iron without compromising taste, appearance, and stability. In one embodiment, the iron may be encapsulated in cellulose, such as a modified cellulose or an ethyl cellulose.

Other ingredients that may be provided in encapsulated form, as herein described, prior to admixture with the ingredients constituting the orally dissolvable compositions include those for which increased stability and prolonged shelf-life is desired. Any one or more of the following ingredients may be provided in encapsulated forms: vitamin A (as vitamin A palmitate), vitamin C (as ascorbic acid), vitamin D₃ (as cholecalciferol), vitamin B₃ (as niacinamide), vitamin B₆ (as pyridoxine hydrochloride), vitamin B₁₂ (as cyanocobalamin), choline (as choline bitartrate), iodine (as potassium iodide), vitamin E (d-alpha tocopheryl acetate), and omega-3 Fatty Acid (as DHA).

The orally dissolvable compositions may include or use a combination of the included vitamins, nutrients, minerals, and other components just described. In a specific embodiment, the orally dissolvable compositions may include one or more of vitamin A, vitamin C, vitamin D₃, vitamin E, vitamin B₁, vitamin B₂, niacin, vitamin B₆, folic acid, vitamin B₁₂, iron, iodine, magnesium, zinc, and copper.

In another embodiment, the orally dissolvable compositions may include one or more of vitamin A, vitamin C, vitamin D₃, vitamin E, vitamin B₁, vitamin B₂, niacin, vitamin B₆, folic acid, vitamin B₁₂, iron, iodine, magnesium, zinc, copper, and omega-3 fatty acids.

In a specific embodiment, the orally dissolvable compositions may comprise vitamin B₆, folic acid, vitamin B₁₂, and iron.

In a specific embodiment, two or more orally dissolvable compositions may include or use vitamin D, vitamin B₆, folic acid, vitamin B₁₂, and one or more flavorants.

In a specific embodiment, the orally dissolvable compositions may use or include vitamin D₃, vitamin B₆, folic acid, vitamin B₁₂, iron, and iodine.

In a specific embodiment, the orally dissolvable compositions may use or include or use vitamin A, vitamin C, vitamin D, vitamin E, niacin, vitamin B₆, folic acid, vitamin B₁₂, iron, iodine, and choline.

In a specific embodiment, the orally dissolvable compositions may include or use about 27 mg iron, about 2.5 mg vitamin B₆, about 1 mg folic acid, and about 12 mcg vitamin B₁₂.

In another embodiment, the vitamins, nutrients and minerals may be included or used in any specific form just described. In another embodiment, the orally dissolvable compositions may include or use a combination of the included vitamins, nutrients and minerals in the ranges or amounts just described.

In another embodiment, the nutritional supplements may include multiple vitamins, nutrients, minerals, and other components in one composition. Providing a single composition multivitamin and multinutrient supplement is an appealing feature because it improves subject compliance. A one orally dissolvable composition or one composition nutritional supplement that includes the beneficial vitamins, nutrients and minerals in appropriate dosage amounts would thus be beneficial for improving patient compliance in, for example, pregnant women.

In another embodiment, the orally dissolvable compositions may include multiple vitamins, nutrients and minerals in more than one composition. In one example, fat soluble compounds such as omega 3 fatty acids, may be included in one composition, whereas water soluble vitamins such as B-complex vitamins and vitamin C may be separated into another composition. In another example, the multiple compositions may be separated due to size or the large dosage amounts of specific ingredients. In another example, the nutritional supplementation of a multivitamin may not be adequate in one composition. Accordingly, all the active ingredients may be divided into a total of two compositions, three compositions, four compositions and five compositions. In one embodiment, each composition may have equal amounts of each active ingredient. In another embodiment, compositions may have unequal amounts of various active ingredients, or merely supplemental amounts of specific active ingredients.

In a specific embodiment, various active ingredients may be incorporated into multiple compositions as a kit. In some embodiments, the orally dissolvable compositions disclosed herein may be packaged as kits using materials known to those of ordinary skill in the art. The kits of the present invention may comprise or use a combination of the included vitamins, nutrients and minerals described herein, in either chelated or non-chelated form. For example, the kits of the present invention may include vitamin A, vitamin B₁, vitamin B₂, vitamin B₃, vitamin B₆, vitamin B₉, vitamin B₁₂, vitamin C, vitamin D₃, vitamin E, iron, iodine, magnesium, zinc, and copper. Additionally or alternatively, kits may further include, by way of example, one or more omega-3 fatty acids, and/or one or more inactive ingredients.

In some embodiments, the kit may be packaged in a sachet or package. In such embodiments, a kit may comprise one or more individual dosage forms. In some embodiments, each kit may comprise two individual dosage forms. In some embodiments, a kit may comprise a total dosage form.

Currently, orally dissolvable film strips may be distributed in individual foil pouches that protect the film strips from moisture, light, etc., and which also offer child resistance, such as, for example, ^{Suboxone}® (buprenorphine and naloxone) 8mg/2mg sublingual films. In embodiments of the invention, the orally dissolvable film strips may be dispensed in accordance with the systems and methods described in, e.g., U.S. Pat. No. 8,911,770, in which the strips are mounted to a backing material and coated in a powder to prevent sticking. Additionally or alternatively, dispensers of the type shown and described in PCT/US2010/023025 and/or PCT/US2004/039582 may also be deployed in distributing the orally dissolvable film strips of the present invention. Embodiments of the invention may also include a dispenser of individual foil-protected film strips as illustrated in U.S. Pat. Publ. No. 2007/0170196. Still further, embodiments of the invention may include those in which the orally dissolvable compositions are provided in a plastic container (e.g., a blister pack) with a dispenser allowing the user to extract one strip at a time as is shown and described in U.S. Pat. No. 7,104,419. Numerous other systems and methods for packaging and distributing orally dissolvable film strips, such as continuous roll dispensers, are discussed and referenced in, for instance, Rajni Bala et al., Orally dissolving strips: A new approach to oral drug delivery system, 3(2) INT. J. PHARM. INVESTIG. 67-76 (Apr-Jun 2013). However, any mechanism for dispensing orally dissolvable strips known in the art may be deployed in conjunction with the present invention.

Additionally or alternatively, in embodiments of the invention, an individual dosage form, unit dosage form, or total dosage form may be individually wrapped, packaged as multiple units on paper strips or in vials of any size, without limitation. The orally dissolvable compositions of the invention may be packaged in unit dose, rolls, bulk bottles, and combinations thereof, without limitation.

In one embodiment, the kit comprises a first composition on a first water-soluble film and a second composition on a second water-soluble film. The first and second compositions may be combined in a single dosage form or they may be provided as separate dosage forms. In one embodiment, the first and second compositions are provided as separate dosage forms. The first composition may comprise, for instance, vitamin A, vitamin C, vitamin D₃, vitamin E, vitamin B₁, vitamin B₂, niacin, vitamin B₆, folic acid, vitamin B₁₂, iron, iodine, magnesium, zinc, and copper. The second water-soluble film may comprise the omega-3 fatty acids.

In another specific embodiment, the orally dissolvable compositions may be used as a dietary supplement. In another embodiment, the orally dissolvable compositions may be used as a prescription prenatal vitamin. In another embodiment, the orally dissolvable compositions, may be administered to a subject, such as a woman during pregnancy, prenatal or who is breast-feeding. In another embodiment, the orally dissolvable compositions may be utilized or administered, once a day, twice a day, three times a day, four times a day and five times a day. When multiple orally dissolvable compositions may be provided in a kit, the compositions may be co-administered at the same or administered separately.

In an embodiment of the invention, each of the water-soluble film strips may be commercially available, and may be combined to form a single composition or can form multiple compositions, which may be co-administered.

The dissolvable compositions may be prepared using conventional methods and materials known in the pharmaceutical art. In preparing the dissolvable composition, any of the usual media may be utilized. The soluble films may be or include one or a combination of polymers such as, for example, pullulan, hydrocolloids, β-glucan, maltodextrin, celluloses, including hydroxypropyl methylcellulose, hydroxyethyl cellulose, hydroxypropyl cellulose, carboxymethyl cellulose, methylcellulose, hydroxymethylcellulose, hydroxyethylcellulose, polyvinyl pyrrolidone, polyvinyl alcohol, sodium alginate, polyethylene glycol, natural gums, such as locust bean gum, carrageenan gum, xanthan gum, tragacanth gum, guar gum, acacia gum, arabic gum, karaya, ghatti, tamarind gum, polyacrylic acid, methyl methacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein.

Typically, these water soluble films may be made by mixing the active ingredients with an ion exchange resin in solution, to encapsulate the active ingredients and help mask their taste. Additional formulation components (coloring agents, sweeteners, plasticizer, defoamer, and the like) are added to create a thick, viscous mixture including both excipients and an active ingredient. This mixture is coated and dried as a film to generate a bulk film roll. If desired, flavor may be added to the dried mixture. The bulk rolls may then be slit into individual ribbons that are separated from the substrate and then cut to individual strips. One ABCD 50 mg is placed between two layers of foil and the primary packaging is generated by heat-sealing the edges to form a sachet.

For example, U.S. Pat. No. 7,357,891 to Yang et al. describes a process for making water-soluble ingestible films by combining a polymer component, polar solvent, and an active component to form a matrix with a uniform distribution of the components. A film is formed from the matrix, and a conveyor surface having top and bottom sides is provided. The film is subsequently fed onto the top side of the surface; and dried by applying hot air to the bottom side of the surface and exposing the film to a temperature above a degradation temperature of the active component. The active components, however, are maintained at the desired level. Embodiments of the invention may also incorporate the additional disclosures relating to this process made in U.S. Pat. No. 8,652,378 to Yang et al. In embodiments of the invention, the drying process may be of the type shown and described in U.S. Pat. No. 9,303,918 to Li. Additionally or alternatively, U.S. Pat. No. 8,765,167 to Myers et al. describes similar compositions and methods which further employ the use of an anti-tacking agent.

Dissolvable compositions may be prepared using conventional methods and materials known in the pharmaceutical art, as shown and described in U.S. Pat. No. 7,897,080 to Yang et al. For instance, such methods describe the preparation of strips by forming a masterbatch pre-mix comprising a solvent and water-soluble and water-swellable polymer. Active ingredients are added to a pre-determined amount of the masterbatch pre-mix to form a flowable polymer matrix having a substantially uniform distribution of the active ingredient. The flowable polymer matrix is cast and at least a portion of the solvent is evaporated from the flowable polymer matrix, forming a visco-elastic film which “locks in” and substantially prevents migration of the active within the visco-elastic film. A resulting film can then be formed from the visco-elastic film. Embodiments of the invention may also incorporate the additional disclosures relating to this process as described in U.S. Pat. Nos. 8,900,497; 8,900,498; 8,906,277; and 9,108,340 to Yang et al.

In an embodiment of the invention, the dissolvable compositions may be prepared using the methods shown and described in U.S. Pat. No. 7,972,618 to Fuisz et al. As shown and described, edible water-soluble film compositions may be prepared using a water-soluble polymer, a foam reducing flavoring agent, and a polar solvent. The foam reducing flavoring agent is added to a master batch before mixing the polymer with the solvent. The film-forming components are mixed under vacuum and wet-cast, and the active ingredient may be added just prior to formation of the film. The polar solvent is removed through a controlled drying process to form the edible water-soluble film, free of added defoaming agents.

U.S. Pat Nos. 7,425,292 and 7,666,337 to Yang et al. further describe compositions and methods for producing such film products with uniform heterogeneity. U.S. Pat. No. 8,603,514 to Yang et al. provides further description relating to the addition of taste-masking agents to these uniform mixtures.

All pharmaceutical preparations described herein are well known to those of ordinary skill in the art, and determination of workable methods for preparing orally dissolvable compositions in any particular instance will generally be within the capability of the person skilled in the art.

Details concerning any of excipients may be found in WADE & WALLER, HANDBOOK OF PHARMACEUTICAL EXCIPIENTS (2nd ed. 1994). AU active ingredients, fillers and excipients are commercially available from companies such as Aldrich Chemical Co., FMC Corp, Bayer, BASF, Alexi Fres, Witco, Mallinckrodt, Rhodia, ISP, and others. The excipients used in the orally dissolvable compositions fall into several functional categories and may include, by way of example, film forming polymers, plasticizer, emulsifier, taste enhancers, sweetener, and flavoring agent. The film former, polyethylene oxide (PEO) is a water-soluble, non-ionic muco-adhesive polymer which helps to rapidly hydrate the film upon application to the tongue. Additionally or alternatively, with the exception of taste masking and flavoring agents, excipients may be of the type used in other FDA-approved oral products, such as, for example, ZUPLENZ® (ondansetron Oral Soluble Film) and SUBOXONE® (buprenorphine/naloxone Sublingual Film).

In one embodiment, the orally dissolvable composition comprises the one or more vitamins, minerals, and nutrients in combination with one or more inactive ingredients. The inactive ingredients may comprise one or more of the following: sugar, com syrup, water, gelatin, citric acid, lactic acid, one or more glazing agents (e.g., vegetable oil, beeswax, camauba wax), one or more natural flavors, one or more natural colors (e.g., black carrot), and one or more masking flavors (e.g., tartaric acid).

In some embodiments, the orally dissolvable compositions may comprise one or more inactive ingredients that include but are not limited to water, buffers (including, by way of example and without limitation, phosphate buffers, citrate buffers, lactic acid, and others known to those of ordinary skill in the art), stabilizing agents (including, by way of example and without limitation, antioxidants (e.g., ascorbic acid, propionic acid, sodium bisulfite, sodium sulfite, and the like), chelating agents (e.g., fumaric acid, sodium edetate, and the like), and others known to those of ordinary skill in the art), surfactants (including, by way of example and without limitation, wetting agents (e.g. sorbitan monolaurate, etc.), antifoaming agents (e.g. sorbitan trioleate, etc.), detergents (e.g. sucrose stearate, etc.), solubilizing agents (e.g. polyethylene glycol 400 monostearate, etc.), and others known to those of ordinary skill in the art), processing aids (e.g. substances used to assist processing, including, by way of example and without limitation, lubricating agents, antioxidants, and others known to those of ordinary skill in the art), lubricating agents (including, by way of example and without limitation, stearic acid, calcium stearate, magnesium stearate, zinc stearate, talc, mineral and vegetable oils, benzoic acid, poly (ethylene glycol), glyceryl behenate, stearyl fumarate, and others known to those of ordinary skill in the art), emulsifiers (including, by way of example and without limitation, synthetic (e.g. sodium lauryl sulfate, potassium laurate, etc.), natural (e.g. gelatin, lecithin, etc.), and finely divided solid emulsifiers (e.g. bentonite, magnesium hydroxide, etc.), and others known to those of ordinary skill in the art), suspending agents (including, by way of example and without limitation, cellulose derivatives (e.g. carboxymethylcellulose, methylcellulose, ethyl cellulose, etc.), natural polymers (e.g. alginates, xanthan gum, guar gum, etc.), synthetic polymers (e.g. carbomers, polyvinyl pyrrolidone, etc.), clays (e.g. magnesium aluminum silicate, hectorite, etc.), and others known to those of ordinary skill in the art), preservatives (including, by way of example and without limitation, benzalkonium chloride, benzethonium chloride, benzyl alcohol, cetrimide, glycerin, propylene glycol, benzoic acid and sodium benzoate, potassium sorbate and sorbic acid, and others known to those of ordinary skill in the art), opaquing agents (including, by way of example and without limitation, titanium dioxide, and others known to those of ordinary skill in the art), glidants (including, by way of example and without limitation, silicon dioxide, colloidal or fumed silica, magnesium stearate, calcium stearate, stearic acid, cornstarch, talc and others known to those of ordinary skill in the art), diluents (including, by way of example and without limitation, corn syrup, lactose, sodium chloride, sucrose (sugar), and others known to those of ordinary skill in the art), colorants or coloring agents (including, by way of example and without limitation, FD&C Red No. 3, FD&C Red No. 20, FD&C Yellow No. 6, FD&C Blue No. 2, D&C Green No. 5, FD&C Orange No. 5, D&C Red No. 8, caramel, ferric oxide, red, pigments, dyes, tints, titanium dioxide, natural coloring agents, such as grape skin extract, beet red powder, beta carotene, annato, carmine, turmeric, paprika, black carrot juice, and others known to those of ordinary skill in the art), sweeteners or sweetening agents (including, by way of example and without limitation, sucrose, fructose, fructose, high fructose corn syrup, dextrose, saccharin sodium, maltodextrin, aspartame, potassium acesulfame, neohesperidin dihydrochalcone, sucralose, monoammonium glycyrrhizinate, and others known to those of ordinary skill in the art), perfuming agents (including, by way of example and without limitation, natural flavor oil, a synthetic flavor oil, and others known to those of ordinary skill in the art), glazing agents (including, by way of example and without limitation, vegetable oil, beeswax, carnauba wax, and others known to those of ordinary skill in the art), flavoring agents or flavorants (including, by way of example and without limitation, natural flavor oil, synthetic flavor oil, and other masking flavors known to those of ordinary skill in the art), and cooling agents (including, by way of example, N-substituted p-menthane-3-carboxamides, such as N-ethyl p-menthane-3-carboxamide (“WS-3”) (Millennium Specialty Chemicals, Jacksonville, Fla.). Additional examples of these and other inactive ingredients are well known in the art. See, e.g., REMINGTON: THE SCIENCE AND PRACTICE OF PHARMACY (21st ed. 2005); WADE & WALLER, HANDBOOK OF PHARMACEUTICAL EXCIPIENTS (2nd ed. 1994).

In some embodiments, the active ingredients, such as the vitamins, minerals, and nutrients of the disclosed invention, may be included in overages. Adding overages of these compounds may be necessary to meet the amounts claimed on the product label and product insert to ensure that those recited amounts are met throughout the shelf life of the product. Indeed, because of U.S. regulatory requirements that label values reflect minimum contents of these nutrients, deviations in actual nutrient content from label values are usually thought to tend toward overages. Dwyer et al., ANAL BIOANAL CHEM, 389:37-45 (2007). In some embodiments, one or more of the vitamins, minerals, and nutrients may be included in the orally dissolvable compositions of the orally dissolvable dosage forms, kits, and methods disclosed herein in overages of the recited, specific labeled amounts of about 100% to about 150% of the labeled amount, although the overages may be dependent on the stability of each ingredient. For example, overages of vitamin D and vitamin B₁₂ may be necessary due to the lack of stability of specific forms. In another example, 5-methyltetrahydrofolate, a form of vitamin B₉, is degraded by light, temperature and may degrade during processing and storage. Overages may be larger for some vitamins particularly those that are less stable and more likely to deteriorate with a long shelf life, those that have other functions (such as antioxidants) in the product itself; for minerals, excess amounts with larger overages are probably less likely because of their increased bulk and shelf life stability. Dwyer et al., ANAL BIOANAL CHEM, 389:37-45 (2007). Accordingly, when overages are included for any specific active ingredient, at some point in time, these ingredients with overages may degrade so that they fall within the labeled amounts. Thus, there is no literal difference between the amounts for active ingredients that include overages, and those amounts listed on the specific label. Furthermore, overages provide an equivalent efficacy of the active ingredient over the shelf life of the product. Accordingly, an active ingredient provided in overage amounts is an insubstantial change in comparison to the specific labeled amount and performs substantially the same function, in substantially the same way, and leads to substantially the same result as the same active ingredient in the labeled amount.

In one embodiment, the vitamins, minerals and nutrients may be provided in amounts that are over the amounts claimed on the labeled amount or that are over the amounts recited herein (overages). Thus, the overage amounts may be the labeled amount plus x % of the labeled amount. The overage amounts may also be the total dosing amount plus x % of the total dosing amount.

The value x may differ for each of the vitamins, minerals and nutrients depending on stability, shelf-life, and toxicity. The value for x may be about 5%, about 6%, about 7%, about 8%, about 9%, about 10%, about 15%, about 20%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%.

It is understood that the value x is determined for each of the vitamins, minerals and nutrients independently as they each have differing characteristics which may require differing overage amounts to ensure that the respective vitamins, minerals and nutrients are provided in the labeled amount for the duration of the shelf-life indicated for the orally dissolvable composition. The vitamins, minerals and nutrients have a broad range of sensitivity to temperature and light and therefore will tend to deteriorate or lose their potency at different rates.

Other objectives, features and advantages of the present invention will become apparent from the following specific examples. The specific examples, while indicating specific embodiments of the invention, are provided by way of illustration only. Accordingly, the present invention also includes those various changes and modifications within the spirit and scope of the invention that may become apparent to those skilled in the art from this detailed description. The invention will be further illustrated by the following non-limiting examples.

Without further elaboration, it is believed that one skilled in the art, using the preceding description, can utilize the present invention to the fullest extent. The following examples are illustrative only, and not limiting of the remainder of the disclosure in any way whatsoever.

### EXAMPLE 1

An orally dissolvable composition comprising the following compositions was prepared, including the appropriate excipients, by standard methods known to those of ordinary skill in the art:

First Water-Soluble Film Strip

| | | |
|---|---|---|
| Vitamin A (Beta Carotene) | 1100 | IU |
| Vitamin C | 60 | mg |
| Vitamin D (Vitamin D₃) | 1000 | IU |
| Vitamin E | 20 | IU |
| Vitamin B₁ | 1.6 | mg |
| Vitamin B₂ (Riboflavin) | 1.8 | mg |
| Vitamin B₃ (Niacinamide) | 15 | mg |
| Vitamin B₆ | 2.5 | mg |
| Vitamin B₉ (Folic Acid) | 1 | mg |
| Vitamin B₁₂ | 12 | μg |
| Iron | 25 | mg |
| Iodine | 150 | μg |
| Magnesium | 20 | mg |
| Zinc | 25 | mg |
| Copper | 2.0 | mg |
| DHA | 200 | mg |

First Water-Soluble Film Strip may contain any one or more of the following optional ingredients: [flavorant, polyvinyl alcohol, xanthan gum, polyacrylic acid, dextrin, pectin, ascorbic acid, FD&C Yellow No. 6, water, dextrose, WS-3, and sorbitan monolaurate.]

The First Water-Soluble Film Strip is provided in an individual, child-resistant, foil pouch.

### EXAMPLE 2

A kit comprising the following orally dissolvable compositions was prepared, including the appropriate excipients, by standard methods known to those of ordinary skill in the art:

First Water-Soluble Film Strip

| | | |
|---|---|---|
| Vitamin B₆ | 4 | mg |
| Vitamin B₉ (Folic Acid) | 1 | mg |
| Vitamin B₁₂ | 15 | μg |
| Iron | 29 | mg |

First Water-Soluble Film Strip may contain any one or more of the following optional ingredients: [propionic acid, flavorant, pullulan, maltodextrin, tamarind gum, carboxyvinyl polymer, amylose, WS-3, FD&C Red No. 3, FD&C Red No. 20, aspartame, potassium acesulfame, sucrose stearate, and edible ink.]

Second Water-Soluble Film Strip

| | |
|---|---|
| DHA | 200 mg |

Second Water-Soluble Film Strip may contain any one or more of the following optional ingredients: [polyvinyl alcohol, polyvinyl pyrrolidone, dextrin, tragacanth gum, ascorbic acid, flavorant, FD&C Red No. 20, water, sucralose, WS-3, sorbitan trioleate, and edible ink.]

The First and Second Water-Soluble Film Strips are provided in individual, child-resistant, foil pouches. The pouches may be provided in a dual plastic pack in the form of a kit and arranged such that the first and second water soluble films together constitute a single recommended dosage form. Instructions may be provided for the first and second water soluble films at substantially the same time or at different times. Instructions may also be provided that the administration of first water soluble film and/or second water soluble film is optional on an as-needed basis in the event that certain symptoms and/or undesirable side effects are being experienced.

### EXAMPLE 3

A kit comprising the following orally dissolvable compositions was prepared, including the appropriate excipients, by standard methods known to those of ordinary skill in the art:

First Water-Soluble Film Strip

| | | |
|---|---|---|
| Vitamin D (Cholecalciferol) | 1500 | IU |
| Vitamin B₆ (Pyridoxine Hydrochloride) | 5 | mg |
| Vitamin B₉ (Folic Acid 0.4 mg and L-Methylfolate | 1 | mg |
| Calcium 0.6 mg) | | |
| Vitamin B₁₂ (Cyanocobalamin) | 20 | μg |

First Water-Soluble Film Strip may contain any one or more of the following optional ingredients: [hydroxyethylcellulose, karaya, flavorant, polyacrylic acid, pectin, ascorbic acid, water, dextrose, and sucrose stearate.]

Second Water-Soluble Film Strip

| | |
|---|---|
| EPA | 200 mg |

Second Water-Soluble Film Strip may contain any one or more of the following optional ingredients: [carrageenan gum, hydroxypropyl cellulose, methylcellulose, hydroxypropylated high amylose starch, WS-3, FD&C Red No. 3, FD&C Red No. 20, aspartame, potassium acesulfame, and sucrose stearate.]

The First and Second Water-Soluble Film Strips may be provided in a two-part plastic pack in the form of a kit and arranged such that the first and second water soluble films together constitute a single recommended dosage form. Instructions may be provided for the first and second water soluble films at substantially the same time or at different times.

### EXAMPLE 4

A study is undertaken to evaluate the effectiveness of the compositions of the present invention in the treatment of subjects. The objective of the study is to determine whether oral intake of the dissolvable compositions results in an improvement of the nutritional status of subjects with regard to the specific vitamins and minerals contained in the administered compositions.

A double-blind, placebo controlled study is conducted over a six-month period. A total of 120 subjects (60 pregnant women entering the second trimester of pregnancy and 60 lactating women), aged 20-35 years, are chosen for the study. An initial assessment of the nutritional status of each subject is conducted. Vitamin A, beta carotene, and vitamin B₆ are measured using high performance liquid chromatography. Erythrocyte transketolase activity is used to measure vitamin B₁ levels. Vitamin B₂ levels are determined by assessment of erythrocyte glutathione reductase activity. Vitamin B₃ levels are assessed by measuring urinary excretion of N′methylnicotinamide and its pyridone. Vitamin B₉ is measured by radioimmunoassay (MA), specifically The Solid Phase No Biol Folic Acid Kit (Diagnostic Products, Los Angeles, CA). Vitamin B₁₂ is measured by MA using human intrinsic factor as a binder. Vitamin C levels are measured by spectrophotometric and colorimetric methods. Vitamin D is measured using an extraction double-antibody MA (Dia Sorin, Inc., Stillwater, Minn.). The peroxide hemolysis test is used to determine vitamin E status. Iron levels are measured using standard spectrophotometry. Similarly, magnesium levels are measured by absorbance of a magnesium chelate with xylidl blue at 660 nM. Zinc levels are assessed using flame atomic absorption spectrometry (Perkins Elmer 460, Norwalk, Conn.). DHA is measured and quantified using gas chromatography procedures.

Additionally, total serum homocysteine levels are determined by extraction on the ^{MultiPrep}® gravity series GVSA-100 column, a strong anion exchange gravity flow column, and measurement by gas chromatography/mass spectrometry. Biochemical Diagnostics, Austin, Texas.

The 120 subjects are separated into four separate groups of 30 women. In a first group comprising only pregnant women and in a second group comprising only lactating women, each subject is administered one dosage form of the composition as described in Example 1 twice a day. In a third group comprising only pregnant women and in a fourth group comprising only lactating women, each subject is administered one placebo dosage form twice a day. Thus, dosage form administration occurs every 12 hours. No other nutritional supplements are taken by the subjects during the assessment period.

An assessment of the nutritional status of each subject is conducted utilizing the methods described above at one month intervals for a six month period. The data is evaluated using multiple linear regression analysis and a standard t-test. In each analysis, the baseline value of the outcome variable is included in the model as a covariant. Treatment by covariant interaction effects is tested by the method outlined by Weigel & Narvaez, 12 CONTROLLED CLINICAL TRIALS 378-94 (1991). If there are no significant interaction effects, the interaction terms are removed from the model. The regression model assumptions of normality and homogeneity of variance of residuals are evaluated by inspection of the plots of residuals versus predicted values. Detection of the temporal onset of effects is done sequentially by testing for the presence of significant treatment effects at 1, 2, 3, 4, 5, and 6 months, proceeding to the earlier time in sequence only when significant effects have been identified at each later time period. Changes from the baseline within each group are evaluated using paired t-tests. In addition, analysis of variance is performed on all baseline measurements and measurable subject characteristics to assess homogeneity between groups. All statistical procedures are conducted using the Statistical Analysis System (SAS Institute Inc., Cary, N.C.). An alpha level of 0.05 is used in all statistical tests.

A statistically significant improvement in the nutritional status of vitamin, mineral, and DHA levels measured is observed in the treated subjects over the controls upon completion of the study. Homocysteine levels in women receiving supplements remain unelevated. Therefore, the study confirms that oral administration of the dissolvable compositions of the present invention is effective in improving the nutritional status of subjects. The length of gestation is increased in women receiving supplements, due to DHA intake, and their homocysteine levels are not elevated, due to folic acid intake, leading to a better prognosis regarding risk of neural tube defects in their infants.

### EXAMPLE 5

A study is undertaken to evaluate the effectiveness of the compositions of the present invention in the treatment of subjects. The objective of the study is to determine whether oral intake of the dissolvable compositions results in an improvement of the nutritional status of subjects with regard to the specific vitamins and minerals contained in the administered compositions. The double-blind, placebo controlled study protocol is identical to that in Example 4, except that each subject is administered one dosage form of the each of the compositions described in Example 2 twice a day. A statistically significant improvement in the nutritional status of vitamin, mineral, and DHA levels measured is observed in the treated subjects over the controls upon completion of the study. Homocysteine levels in women receiving supplements remain unelevated. Therefore, the study confirms that oral administration of the dissolvable compositions of the present invention in a kit is effective in improving the nutritional status of subjects.

While specific embodiments of the present invention have been described, other and further modifications and changes may be made without departing from the spirit of the invention. All further and other modifications and changes are included that come within the scope of the invention as set forth in the claims. The disclosure of each publication cited above is expressly incorporated by reference in its entirety to the same extent as if each were incorporated by reference individually.

1. A composition for administration to a pre-natal, pregnant, post-natal or breastfeeding subject, the orally dissolvable composition comprising:
a first water-soluble film comprising one or more vitamins and minerals selected from the group consisting of: vitamin A, vitamin C, vitamin D₃, vitamin E, vitamin B₁, vitamin B₂, niacin, vitamin B₆, folic acid, vitamin B₁₂, iron, iodine, magnesium, zinc, and copper.

2. The composition of claim 1, further comprising omega-3 fatty acids.

3. The composition of claim 2, wherein the omega-3 fatty acids comprise one or more of DHA and EPA.

4. The composition of claim 2, wherein the omega-3 fatty acids is derived from algae.

5. The composition of claim 2, wherein the omega-3 fatty acids are provided on a second water-soluble film.

6. The composition of claim 1, wherein the one or more vitamins and minerals comprise iron, vitamin B₆, folic acid, and vitamin B₁₂.

7. The composition of claim 6, wherein the one or more vitamins and minerals comprise about 27 mg iron, about 2.5 mg vitamin B₆, about 1 mg folic acid, and about 12 mcg vitamin B₁₂.

8. The composition of claim 1, wherein the one or more vitamins comprise folic acid, vitamin D, vitamin B₆, vitamin B₁₂, wherein the composition further comprises one or more flavorants.

9. The composition of claim 8, wherein the one of more vitamins and minerals comprise at least about 1 mg of folic acid, about 500 IU to about 2,000 IU of vitamin D, about 2 mg to about 5 mg of vitamin B₆, at least about 6 mcg to about 20 mcg of vitamin B₁₂, and wherein the first water-soluble film further comprises at least about 0 mg to about 200 mg of the one or more flavorants.

10. The composition of claim 1, wherein the one or more vitamins and minerals comprise:
vitamin D₃, vitamin B₆, folic acid, vitamin B₁₂, iron and iodine.

11. The composition of claim 1, wherein the one or more vitamins and minerals comprise:
vitamin A, vitamin C, vitamin D, vitamin E, niacin, vitamin B₆, folic acid, vitamin B₁₂, iodine, iron, and choline.

12. The composition of claim 1, wherein a total amount of the one or more vitamins and minerals on the first water-soluble film is about 50 mg or less.

13. The composition of claim 12, wherein the total amount is about 30 mg or less.

14. The composition of claim 1, wherein the iron is encapsulated.

15. The composition of claim 1, wherein the folic acid is encapsulated.

16. The composition of claim 5, wherein one or more of the first or second water soluble films comprises one or a combination of polymers selected from the group consisting of: pullulan, hydrocolloids, β-glucan, maltodextrin, celluloses, including hydroxypropylmethyl cellulose, hydroxyethyl cellulose, hydroxypropyl cellulose, carboxymethyl cellulose, methylcellulose, hydroxymethylcellulose, hydroxyethylcellulose, polyvinyl pyrrolidone, polyvinyl alcohol, sodium alginate, polyethylene glycol, natural gums, such as locust bean gum, carrageenan gum, xanthan gum, tragacanth gum, guar gum, acacia gum, arabic gum, karaya, ghatti, tamarind gum, polyacrylic acid, methyl methacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein.

17. The composition of claim 5, wherein one or more of the first or second water-soluble films does not comprise an ingredient derived from animal sources.

18. The composition of claim 5, wherein one or more of the first or second water-soluble films consist of ingredients derived only from plant sources.

19. The composition of claim 5, wherein one or more of the first or second water-soluble films may comprise one or more of a stabilizing agent, a coloring agent, water, a sweetening agent, a cooling agent, and a surfactant.

20. A kit comprising:
a first water-soluble film comprising vitamins and minerals, the vitamins and minerals being one or more selected from the group consisting of: vitamin A, vitamin C, vitamin D₃, vitamin E, vitamin B₁, vitamin B₂, niacin, vitamin B₆, folic acid, vitamin B₁₂, iron, iodine, magnesium, zinc, and copper, and one or more pharmaceutically-acceptable carriers; and
a second water-soluble film.

21. The kit of claim 20, wherein the second water-soluble film further comprises omega-3 fatty acids and one or more pharmaceutically-acceptable carriers.

22. The kit of claim 21, wherein the omega-3 fatty acids comprise one or more of DHA and EPA.

23. The kit of claim 21, wherein the omega-3 fatty acids is derived from algae.

24. The kit of claim 20, wherein the first water-soluble film comprises iron, vitamin B₆, folic acid, and vitamin B₁₂.

25. The kit of claim 24, wherein the first water-soluble film comprises about 27 mg iron, about 2.5 mg vitamin B₆, about 1 mg folic acid, and about 12 mcg vitamin B₁₂.

26. The kit of claim 20, wherein the first water-soluble film comprises folic acid, vitamin D, vitamin B₆, vitamin B₁₂, the first water-soluble film further comprising one or more flavorants.

27. The kit of claim 26, wherein the first water-soluble film comprises at least about 1 mg of folic acid, about 500 IU to about 2,000 IU of vitamin D, about 2 mg to about 5 mg of vitamin B₆, at least about 6 mcg to about 20 mcg of vitamin B₁₂, and wherein the first water-soluble film further comprises at least about 0 mg to about 200 mg of the one or more flavorants.

28. The kit of claim 20, wherein the first water-soluble film comprises: vitamin D₃, vitamin B₆, folic acid, vitamin B₁₂, iron and iodine.

29. The kit of claim 20, wherein the first water-soluble film comprises: vitamin A, vitamin C, vitamin D, vitamin E, niacin, vitamin B₆, folic acid, vitamin B₁₂, iodine, iron, and choline.

30. The kit of claim 20, wherein a total amount of the one or more vitamins and minerals on the first water-soluble film is about 50 mg or less.

31. The kit of claim 30, wherein the total amount is about 30 mg or less.

32. The kit of claim 20, wherein the iron is encapsulated.

33. The kit of claim 20, wherein the folic acid is encapsulated.

34. The kit of claim 20, wherein one or more of the first or second soluble films comprises one or a combination of polymers selected from the group consisting of: pullulan, hydrocolloids, β-glucan, maltodextrin, celluloses, including hydroxypropylmethyl cellulose, hydroxyethyl cellulose, hydroxypropyl cellulose, carboxymethyl cellulose, methylcellulose, hydroxymethylcellulose, hydroxyethylcellulose, polyvinyl pyrrolidone, polyvinyl alcohol, sodium alginate, polyethylene glycol, natural gums, such as locust bean gum, carrageenan gum, xanthan gum, tragacanth gum, guar gum, acacia gum, arabic gum, karaya, ghatti, tamarind gum, polyacrylic acid, methyl methacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein.

35. The kit of claim 20, wherein one or more of the first or second water-soluble films does not comprise an ingredient derived from animal sources.

36. The kit of claim 20, wherein one or more of the first or second water-soluble films consist of ingredients derived only from plant sources.

37. The kit of claim 20, wherein one or more of the first or second water-soluble films may comprise one or more of a stabilizing agent, a coloring agent, water, a sweetening agent, a cooling agent, and a surfactant.

38. A method comprising providing the kit of claim 20 to one or more subjects.

39. A method for treating a pre-natal, pregnant, post-natal or breastfeeding subject for a nutritional deficiency, the method comprising:
administering a first water-soluble film to the subject to treat the subject for nutritional deficiency, wherein the first water-soluble film is provided in a single homogenous mixture which is administered to the subject either buccally or sublingually.

40. The method of claim 39, wherein the first water-soluble film comprises an effective amount of one or more vitamins and minerals selected from the group consisting of:
vitamin A, vitamin C, vitamin D₃, vitamin E, vitamin B₁, vitamin B₂, niacin, vitamin B₆, folic acid, vitamin B₁₂, iron, iodine, magnesium, zinc, and copper.

41. The method of claim 40, wherein the first water-soluble film further comprises omega-3 fatty acids.

42. The method of claim 41, wherein the omega-3 fatty acids is derived from algae.

43. The method of claim 40, further comprising omega-3 fatty acids provided on a second water-soluble film.

44. The method of claim 40, wherein the one or more vitamins and minerals comprise iron, vitamin B₆, folic acid, and vitamin B₁₂.

45. The method of claim 44, wherein the one or more vitamins and minerals comprise about 27 mg iron, about 2.5 mg vitamin B₆, about 1 mg folic acid, and about 12 mcg vitamin B₁₂.

46. The method of claim 40, wherein the one or more vitamins comprise folic acid, vitamin D, vitamin B₆, vitamin B₁₂, wherein the first water soluble film further comprises one or more flavorants.

47. The method of claim 46, wherein the one of more vitamins and minerals comprise at least about 1 mg of folic acid, about 500 IU to about 2,000 IU of vitamin D, about 2 mg to about 5 mg of vitamin B₆, at least about 6 mcg to about 20 mcg of vitamin B₁₂, and wherein the first water-soluble film further comprises at least about 0 mg to about 200 mg of the one or more flavorants.

48. The method of claim 40, wherein the one or more vitamins and minerals comprise: vitamin D₃, vitamin B₆, folic acid, vitamin B₁₂, iron and iodine.

49. The method of claim 40, wherein the one or more vitamins and minerals comprise: vitamin A, vitamin C, vitamin D, vitamin E, niacin, vitamin B₆, folic acid, vitamin B₁₂, iodine, iron, and choline.

50. The method of claim 39, wherein a total amount of the one or more vitamins and minerals on the first water-soluble film is about 50 mg or less.

51. The method of claim 50, wherein the total amount is about 30 mg or less.

52. The method of claim 40, wherein the iron is encapsulated.

53. The method of claim 40, wherein the folic acid is encapsulated.

54. The method of claim 43 wherein one or more of the first or second water soluble films comprises one or a combination of polymers selected from the group consisting of: pullulan, hydrocolloids, β-glucan, maltodextrin, celluloses, including hydroxypropylmethyl cellulose, hydroxyethyl cellulose, hydroxypropyl cellulose, carboxymethyl cellulose, methylcellulose, hydroxymethylcellulose, hydroxyethylcellulose, polyvinyl pyrrolidone, polyvinyl alcohol, sodium alginate, polyethylene glycol, natural gums, such as locust bean gum, carrageenan gum, xanthan gum, tragacanth gum, guar gum, acacia gum, arabic gum, karaya, ghatti, tamarind gum, polyacrylic acid, methyl methacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein.

55. The method of claim 43, wherein one or more of the first or second water-soluble films does not comprise an ingredient derived from animal sources.

56. The method of claim 43, wherein one or more of the first or second water-soluble films consist of ingredients derived only from plant sources.

57. The method of claim 43, wherein one or more of the first or second water-soluble films may comprise one or more of a stabilizing agent, a coloring agent, water, a sweetening agent, a cooling agent, and a surfactant.

58. The method of claim 43, wherein the first and second water-soluble film strips are co-administered to the subject.
